(19) United States
(12) Patent Application Publication
(10) Pub. No.: US 2013/0003857 A1
(43) Pub. Date: Jan. 3, 2013

(54) METHODS AND SYSTEM FOR USING A SCAN CODING PATTERN DURING INTER CODING

(75) Inventors: Yue Yu, San Diego, CA (US); Jian Lou, San Diego, CA (US); Krit Panusopone, San Diego, CA (US); Limin Wang, San Diego, CA (US)

(73) Assignee: GENERAL INSTRUMENT CORPORATION, Horsham, PA (US)

(21) Appl. No.: 13/538,722

(22) Filed: Jun. 29, 2012

Related U.S. Application Data
(60) Provisional application No. 61/502,850, filed on Jun. 29, 2011.
(60) Provisional application No. 61/504,690, filed on Jul. 5, 2011.
(60) Provisional application No. 61/525,699, filed on Aug. 19, 2011.
(60) Provisional application No. 61/528,652, filed on Aug. 29, 2011.

(51) Int. Cl. H04N 7/30

(52) U.S. Cl. 375/240.18; 375/E07.226

(57) ABSTRACT

A method for processing a block of transform coefficients during inter coding includes receiving, during inter coding, an N×M block of transform coefficients, wherein N is a row width of the block and M is a column height of the block. The method further includes partitioning the N×M block into a plurality of sub-blocks each comprising a plurality of the transform coefficients; and processing the plurality of sub-blocks, one at a time, in a coding order along a first diagonal scan coding pattern to generate a bit sequence corresponding to the N×M block. The processing comprises, for the sub-blocks containing at least one non-zero transform coefficient, coding at least the non-zero transform coefficients in a transform coefficient sequence along a second diagonal scan coding pattern.

### RELATED APPLICATIONS

The present application is related to and claims benefit under 35 U.S.C. §119(e) from the following U.S. Provisional patent applications commonly owned with this application by Motorola Mobility LLC:
Ser. No. 61/502,850, filed Jun. 29, 2011, titled “Adaptive Scan for Large Blocks for HEVC” (attorney docket no. CS38971);
Ser. No. 61/504,690, filed Jul. 5, 2011, titled “Method and Adaptive Scan for Large Blocks for HEVC” (attorney docket no. CS38993);
Ser. No. 61/525,699, filed Aug. 19, 2011, titled “Adaptive Scan for Inter Blocks for HEVC” (attorney docket no. CS39186); and
Ser. No. 61/528,652, filed Aug. 29, 2011, titled “Adaptive Scan for Intra Coding for HEVC” (attorney docket no. CS39211), the entire contents of each being incorporated herein by reference.

The present application is also related to the following U.S. patent application commonly owned with this application by Motorola Mobility LLC: Ser. No. TBD, filed concurrently herewith and titled “Method and System for using a Scan Coding Pattern during Intra Coding” (attorney docket no. CS38971), the entire contents of which are incorporated herein by reference.

### FIELD OF THE DISCLOSURE

The present disclosure relates generally to data compression and more particularly to methods and a system for using a scan coding pattern during inter coding of a video picture.

### BACKGROUND

A growing need has arisen for higher compression of video media for various applications such as videoconferencing, digital media storage, television broadcasting, internet video streaming and communication. Video, which comprises a sequence of images or “pictures,” undergoes compression during an encoding process performed by an encoder. The encoding process produces a bitstream (also referred to herein as a bit sequence), from the video, which can be stored or transmitted over a physical medium. A decoder performs a decoding process to read the bitstream and, thereby, derive the sequence of pictures of the video. As used herein, the term “coding” is used to refer to processes and algorithms used during either the encoding process or the decoding process or both, and the term coding is used interchangeably with the term encoding and the term decoding herein.

The video coding process comprises a plurality of algorithms some of which are properly arranged to achieve video compression by reducing redundant information within and between the video frames. One of these algorithms is entropy coding, which, in the encoder, generates the bitstream of the video from two-dimensional arrays of quantized transform coefficients and performs the inverse process in the decoder. More particularly, in the prior art, in the encoder the quantized transform coefficients of two-dimensional arrays corresponding to a macroblock (i.e., a 16×16 block of pixels) are entropy coded in a one-dimensional sequence along a forward direction of a scan coding pattern. In the decoder, entropy decoding is used to generate macroblocks from a received bitstream. Since more robust and flexible video compression techniques are currently being developed, such as the High Efficiency Video Coding (HEVC) draft standard (also known as H.265 and MPEG-H Part 2), more flexible uses of scan coding patterns for coding (such as entropy coding) is needed.

Accordingly, there is a need for methods and a system for using a scan coding pattern during inter coding of data.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of an encoder implementing a method for processing a block of transform coefficients using a scan coding pattern during coding of video data in accordance with an embodiment.

FIG. 2 is a flowchart of a method for using a scan coding pattern during coding of video data in accordance with an embodiment.

FIG. 3 illustrates use of wavefront, horizontal, and vertical scan coding patterns in accordance with an embodiment.

FIG. 4 illustrates use of wavefront, horizontal, and vertical scan coding patterns in accordance with an embodiment.

FIG. 5 illustrates use of a wavefront scan coding pattern in accordance with an embodiment.

FIG. 6 illustrates use of a wavefront scan coding pattern in accordance with an embodiment.

FIG. 7 (i.e., collectively 7A and 7B) illustrates use of zigzag, wavefront, horizontal, and vertical scan coding patterns in accordance with an embodiment.

FIG. 8 (i.e., collectively 8A and 8B) illustrates use of zigzag, wavefront, horizontal, and vertical scan coding patterns in accordance with an embodiment.

FIG. 9 illustrates use of a zigzag scan coding pattern in accordance with an embodiment.

FIG. 10 illustrates use of a wavefront scan coding pattern in accordance with an embodiment.

FIG. 11 illustrates use of a horizontal scan coding pattern in accordance with an embodiment.

FIG. 12 illustrates use of a vertical scan coding pattern in accordance with an embodiment.

FIG. 13 illustrates use of a zigzag scan coding pattern in accordance with an embodiment.

FIG. 14 illustrates use of a wavefront scan coding pattern in accordance with an embodiment.

FIG. 15 illustrates use of a horizontal scan coding pattern in accordance with an embodiment.

FIG. 16 illustrates use of a vertical scan coding pattern in accordance with an embodiment.

FIG. 17 illustrates use of a horizontal scan coding pattern in accordance with an embodiment.

FIG. 18 illustrates use of a horizontal scan coding pattern in accordance with an embodiment.

FIG. 19 illustrates use of a horizontal scan coding pattern in accordance with an embodiment.

FIG. 20 illustrates use of a horizontal scan coding pattern in accordance with an embodiment.

FIG. 21 illustrates use of a vertical scan coding pattern in accordance with an embodiment.

FIG. 22 illustrates use of a vertical scan coding pattern in accordance with an embodiment.

FIG. 23 illustrates use of a vertical scan coding pattern in accordance with an embodiment.

FIG. 24 illustrates use of a vertical scan coding pattern in accordance with an embodiment.

FIG. 25 illustrates context models for coding along forward and reverse directions of horizontal and vertical scan coding patterns in accordance with an embodiment.

FIG. 26 illustrates context models for coding along a forward direction of horizontal and vertical scan coding patterns in accordance with an embodiment.

FIG. 27 illustrates context models for coding along a reverse direction of horizontal and vertical scan coding patterns in accordance with an embodiment.

FIG. 28 illustrates a coding order for sub-blocks of a transform unit block along zigzag, horizontal, and vertical scan coding patterns in accordance with an embodiment.

FIG. 29 illustrates a coding order for sub-blocks of a transform unit block along zigzag, horizontal, and vertical scan coding patterns in accordance with an embodiment.

FIG. 30 illustrates a coding order for sub-blocks of a transform unit block along zigzag, horizontal, and vertical scan coding patterns in accordance with an embodiment.

FIG. 31 illustrates use of a horizontal scan coding pattern for coefficient level and sign coding of a transform unit block in accordance with an embodiment.

FIG. 32 illustrates use of a vertical scan coding pattern in accordance with an embodiment.

FIG. 33 illustrates use of a vertical scan coding pattern in accordance with an embodiment.

FIG. 34 illustrates use of a vertical scan coding pattern in accordance with an embodiment.

FIG. 35 illustrates use of a horizontal scan coding pattern in accordance with an embodiment.

FIG. 36 illustrates use of a horizontal scan coding pattern in accordance with an embodiment.

FIG. 37 illustrates a horizontal scan coding pattern in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides methods and a system for using a scan coding pattern during inter coding. One method includes receiving, during inter coding, an N×M block of transform coefficients, wherein N is a row width of the block and M is a column height of the block. The method further includes partitioning the N×M block into a plurality of sub-blocks each comprising a plurality of the transform coefficients; and processing the plurality of sub-blocks, one at a time, in a coding order along a first diagonal scan coding pattern to generate a bit sequence corresponding to the N×M block. The processing comprises, for the sub-blocks containing at least one non-zero transform coefficient, coding at least the non-zero transform coefficients in a transform coefficient sequence along a second diagonal scan coding pattern.

Further in accordance with the present teachings is a method, performed by a decoder during inter coding, for processing a bit sequence. The method includes receiving, during inter coding, a bit sequence corresponding to an N×M block of transform coefficients, wherein N is a row width of the block and M is a column height of the block. The method further includes processing the bit sequence to generate a plurality of sub-blocks each comprising a plurality of the transform coefficients, wherein the sub-blocks are generated, one at a time, in a decoding order along a first diagonal scan coding pattern to form the N×M block of transform coefficients. The processing comprises, for the sub-blocks containing at least one non-zero transform coefficient, decoding a portion of the bit sequence to generate the transform coefficients in a transform coefficient sequence along a second diagonal scan coding pattern.

Further in accordance with the present teachings is a system for encoding and decoding video data. The system includes a decoder configured to receive, during inter coding, a first bit sequence corresponding to a first N×M block of transform coefficients, wherein N is a row width of the first block and M is a column height of the first block; and process the first bit sequence to generate a first plurality of sub-blocks each comprising a plurality of the transform coefficients of the first block, wherein the sub-blocks of the first plurality are generated, one at a time, in a decoding order along a first wavefront scan coding pattern to form the first N×M block of transform coefficients.

The system further includes an encoder configured to receive, during inter coding, a second N×M block of transform coefficients, wherein N is a row width of the second block and M is a column height of the second block. The encoder is further configured to partition the second N×M block into a second plurality of sub-blocks each comprising a plurality of the transform coefficients of the second block; and process the second plurality of sub-blocks, one at a time, in a coding order along a second wavefront scan coding pattern to generate a second bit sequence corresponding to the second N×M block.

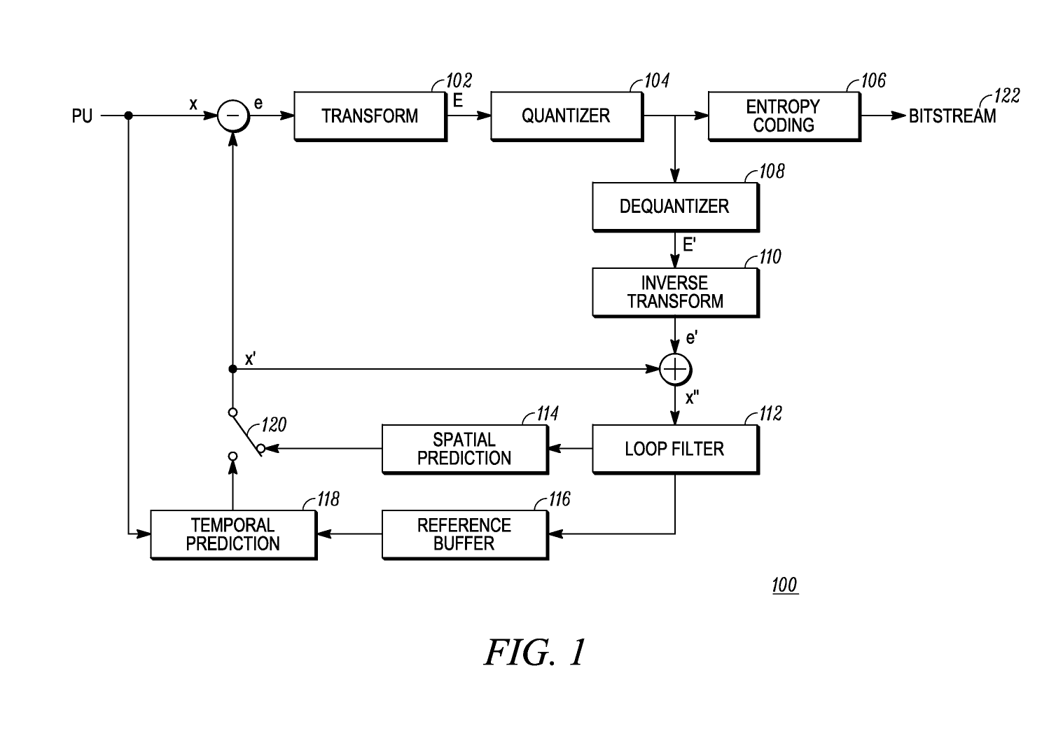

Referring now to the drawings, and in particular FIG. 1, an illustrative simplified block diagram of an encoder implementing a method for processing a block of transform coefficients using a scan coding pattern during video coding in accordance with an embodiment is shown and indicated generally at 100. Encoder 100 comprises a transform block 102, a quantizer block 104, an entropy coding block 106, a dequantizer block 108, an inverse transform block 110, a loop filter 112, a spatial prediction block 114, a reference buffer 116, a temporal prediction block 118, and a switch 120. In an embodiment, the encoder 100 is an HEVC encoder, meaning that the encoder performs data (e.g., video data) processing in compliance with at least portions of the HEVC draft standard or a future HEVC standard not yet published (collectively referred to herein as HEVC or the HEVC specification). However, in alternative embodiments, the encoder 100 implements data (e.g., video, audio or other media) processing that is compliant with other standard or proprietary media compression techniques. Moreover, the block diagram of the encoder 100 is “simplified” in that it only shows those blocks necessary to understand the embodiments of the present teachings. Other elements of a commercial encoder embodiment are omitted for ease of illustration.

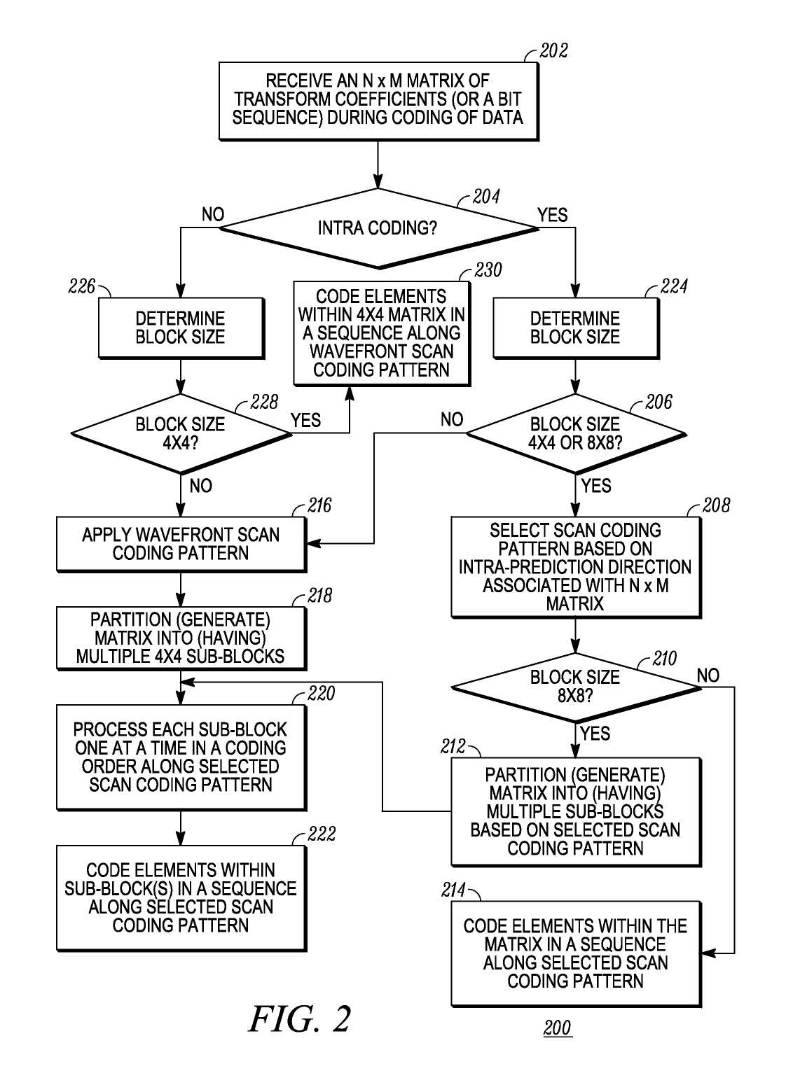

The transform block 102, quantizer block 104, entropy coding block 106, dequantizer block 108, inverse transform block 110, spatial prediction block 114, and temporal prediction block 118 represent different algorithms used by the encoder 100 to perform its functionality, including the functionality described with respect to the present teachings, for instance as described below by reference to the remaining FIGS. 2-37. In one embodiment, the algorithms 102-110, 114 and 118, and the loop filter 112, reference buffer 116, and switch 120 are completely implemented in hardware on an integrated circuit chip. In an alternate embodiment, the algorithms 102-110, 114 and 118 are stored as software or firmware code on a suitable storage device (i.e., memory) and the encoder is partially implemented in hardware as a processing device that is programmed to run the algorithms stored in memory.

HEVC is a block based hybrid spatial and temporal predictive coding scheme. In HEVC, an input picture is first divided into square blocks, defined as largest coding units (LCUs). As used herein, a block is defined as a two-dimensional array or matrix of elements or samples such as pixels, quantized transform coefficients, values of a significance map, etc., depending on the particular type of block and the processing that the block has undergone. As such, the terms block, array, and matrix are used interchangeable herein. Unlike other video coding standards where the basic coding unit is a macroblock (MB) of 16×16 pixels, in HEVC, the basic coding unit, the LCU, can be as large as 128×128 pixels, which provides greater flexibility during the encoding process to adapt compression and prediction to image peculiarities.

In HEVC, a LCU can be divided (i.e., split or partitioned) into four square blocks, defined as coding units (CUs), each a quarter size of the LCU. Each CU can be further split into four smaller CUs, each a quarter size of the CU. The splitting process can be repeated until certain criteria are met, such as depth level or rate-distortion (RD) criteria. For example, the partitioning that gives the lowest RD cost is selected as the partitioning for the LCUs. Accordingly, in HEVC, CUs define a partitioning of a picture into multiple regions, and the CU replaces the macroblock structure and contains one or several blocks defined as prediction units (PUs) and transform units (TUs), described in more detail below.

HEVC uses a quadtree data representation to describe an LCU partition, which is how the LCU is split into CUs. Specifically, at each node of the quadtree, a bit “1” is assigned if the node is further split into four sub-nodes, otherwise a bit “0” is assigned. The quadtree representation of binary data is coded along with the CUs and transmitted as overhead, to use in the decoding process. At each leaf of a quadtree, a final CU having dimensions of 2 L×2 L (where 2 L is equal to both a row width and a column height of the final CU) can possess one of four possible block dimensions, wherein block dimensions of 2 L×2 L, 2 L×L, L×2 L and L×L inside each CU pattern is defined as a prediction unit (PU). Thus, the largest PU size is equal to the CU size, and other allowed PU sizes depend on the prediction type, i.e., intra prediction or inter prediction.

A prediction unit is defined herein as the elementary unit for prediction during the coding process. At the level of CU, either intra (spatial) or inter (temporal) prediction is selected by a controller for the encoder (not shown in FIG. 1), which provides a control signal to the switch 120 (of FIG. 1) to indicate the type of prediction that was selected. The selected prediction type is then applied to all PUs within the CU. Data indicating a coding mode (i.e., intra mode or inter mode) and intra prediction direction for intra mode accompanies the video data for storage or transmission in a bitstream to a decoder. In addition, the coding mode and intra prediction direction data is accessible to the encoding (and decoding) algorithms, for example, via the controller (not shown) for the encoder.

More particularly, HEVC supports intra pictures (i.e., I pictures or frames) and inter pictures (e.g., B and P pictures or frames). Intra pictures are independently coded without reference to any other picture and, thereby, provide a possible point where decoding can begin. Hence, only spatial prediction is allowed for intra coding a CU (by coding the corresponding TUs) inside an intra picture. As used herein, intra coding (or coding in intra mode) means coding of a block using an intra (spatial) prediction algorithm (e.g., 114 of FIG. 1), wherein spatial prediction utilizes spatial correlation within a picture to reduce the amount of transmission data necessary to represent the picture. The block that is intra coded is referred to herein as an intra block. A prediction mode defines a method for generating a signal from previously encoded data, i.e., either spatial or temporal, that minimizes the residual between the prediction and the original.

By contrast, inter pictures are coded using inter prediction, which is prediction derived from data elements of reference pictures other than the current picture. Inter coding (or coding in inter mode), which is defined herein as coding of a block using a temporal (inter) prediction algorithm (e.g., 118 of FIG. 1), provides most of the video compression. This is because with inter coding only the differences between a picture and a temporal reference is coded by extracting motion information from the pictures using the temporal prediction algorithm. Temporal references are previously coded intra or inter pictures. Inter pictures support both intra and inter prediction. The block that is inter coded is referred to herein as an inter block.

As implied above, a CU can be either spatially coded (in intra mode) or temporally predictive coded (in inter mode). If a CU is coded in intra mode, each PU of the CU can have its own spatial prediction direction. If a CU is coded in inter mode, each PU of the CU can have its own motion vector(s) and associated reference picture(s). Returning again to the description of FIG. 1, HEVC encoder 100 operates, in general, as follows for implementing CU coding. In one embodiment, given a current PU block of pixels corresponding to video data, a prediction PU, x′, is first obtained through either spatial prediction using the spatial prediction block 114 or temporal prediction using the temporal prediction block 118, depending on the placement of the switch 120. The prediction PU is then subtracted from the current PU, resulting in a residual PU, e.

HEVC offers thirty five possible angular spatial prediction directions per PU, including, but not limited to, horizontal, vertical, 45-degree diagonal, 135-degree diagonal, DC, etc. The prediction directions have angles of +/−[0,2,5,9,13,17,21,26,32,33,34]. Any suitable syntax can be used to indicate the spatial prediction direction per PU. Temporal prediction is performed through a motion estimation operation. The motion estimation operation searches for a best match prediction for the current PU over reference pictures generated using a decoding process within the encoder 100 (i.e., the dequantizer 108, the inverse transform 110, and the loop filter 112) and stored in the reference buffer 116. The best match temporal prediction is described by motion vector (MV) and associated reference picture (refIdx). A PU in B picture can have up to two MVs. Both MV and refIdx, in accordance with a suitable syntax, is provided by the temporal prediction block 118.

Transform unit blocks (TUs) of pixels (corresponding to the residual PU, e, and the CU that includes the PU) undergo the operation of transform within the transform block 102, resulting in TUs in the transform domain, E, each comprising a plurality of transform coefficients corresponding to video data. In HEVC, a set of block transforms (TUs) of different sizes may be applied to a CU. More particularly, a TU can be the same size as or exceed the size of the PU but not the CU; or a PU can contain multiple TU. The size and location of each TU within a CU is identified by a separate quadtree, called a RQT, which accompanies the coded CU for storage or transmission in a bitstream to a decoder. Moreover, the data included in the RQT is accessible to the encoding (and decoding) algorithms, for example, via the controller (not shown) for the encoder. More particularly, HEVC uses a block transform operation, which tends to decorrelate the pixels within the TU block and compact the block energy into low order transform coefficients, which are defined as scalar quantities considered to be in a frequency domain. In an embodiment, the transform block 102 performs a Discreet Cosign Transform (DCT) of the pixels within the TU block. The TU is defined herein as the block unit or block of elements processed during the transform, quantization, and entropy coding operations.

The output, E, of the transform block 102 is a transform unit block comprising a two-dimensional array or matrix of transform coefficients. The transform coefficients of the residual TU, E, are quantized in the quantizer block 104 to generate a transform unit block comprising a two-dimensional matrix of quantized transform coefficients. The transform coefficients output from the transform block 102 and the quantized transform coefficients output from the quantizer 104 are referred to herein, in general, as “transform coefficients,” or “coefficients” since each set of coefficients are scalar quantities considered to be in the frequency domain. Also, when skip transform is used, one or more transform units may be skipped during the quantization process; and when pulse code modulation (PCM) mode or lossless mode is used, the quantization process is not used. A matrix of elements resulting from these two scenarios is also considered as a TU having “transform coefficients” for the purposes of these teachings. However, quantization plays a very important role in data compression. In HEVC, quantization converts the high precision transform coefficients into a finite number of possible values. Quantization is a lossy operation, and the loss by quantization cannot be recovered.

The quantized transform coefficients are entropy coded, resulting in a final compression bitstream 122 (also referred to herein as a one-dimensional “bit sequence”) from the encoder 100. In HEVC, entropy coding is performed using context-adaptive binary-arithmetic coding (CABAC). Other video compression techniques use CABAC as well as other entropy coding algorithms such as context-adaptive variable-length coding (CAVLC). When a video compression technique offers both CAVLC and CABAC, it can be said that an encoder (or decoder) that can implement both of these entropy coding techniques operates in accordance with two configurations: a low complexity configuration, when implementing CAVLC entropy coding and a high efficiency configuration when implementing CABAC entropy coding.

With CABAC coding, transform coefficients within a logical TU block are coded with a context model, and the TU of transform coefficients is coded in three parts. First, a “sub-block level” significance map corresponding to the TU of transform coefficients is coded (which is also referred to herein as L1 coding). In accordance with the present teachings, the TU is divided or partitioned into a plurality of sub-blocks for coding, wherein each sub-block contains a plurality of the transform coefficients, and in one embodiment a different plurality of the transform coefficients. The sub-block level significance map indicates (e.g., with a binary value of 0) that a particular sub-block of the TU contains all zero coefficients or indicates (e.g., with a binary value of 1) that a particular sub-block of the TU contains at least one non-zero coefficient. Where a sub-block has an associated binary value of 0 in the sub-block level significance map (i.e., a zero sub-block), this signals the decoder that no further processing of that sub-block (e.g., no decoding of the transform coefficients within that sub-block) is required. A non-zero sub-block is a sub-block that has an associated binary value of 1 in the sub-block level significance map.

Second, coding of the TU block of transform coefficients comprises coding a “coefficient-level” significance map corresponding to each sub-block having at least one non-zero transform coefficient and having the same dimensions as the sub-block (which is also referred to herein as L0 coding). The coefficient-level significance map is used to indicate to the decoder whether a corresponding transform coefficient is zero or non-zero at each position of a given sub-block. L0 and L1 coding is collectively referred to herein as “two-level” significance map coding.

Third, coding of the TU block of transform coefficients, or more particularly coding of the non-zero sub-blocks of the TU block, comprises coding at least the non-zero transform coefficients and corresponding sign information within a sub-block. In an embodiment, both zero and non-zero transform coefficients and the associated sign information is coded. This third aspect of coding the transform coefficients within a sub-block is referred to herein as “level and sign” coding, wherein the “level” is defined as the transform coefficient value. Values within a block or matrix, including transform coefficients within a TU and values within a significance map, are referred to herein collectively as “elements”.

In the decoding process within encoder 100, the quantized transform coefficients of the residual TU are dequantized in the dequantizer block 108 (an inverse (but not exactly) operation of the quantizer block 104), resulting in dequantized transform coefficients of the residual TU, E′. The dequantized transform coefficients of the residual TU, E′, are inverse transformed in the inverse transform block 110 (an inverse of the transform block 102), resulting in a reconstructed residual TU, e′. The reconstructed residual TU, e′, is then added to the corresponding prediction, x′, either spatial or temporal, to form a reconstructed PU, x″. In HEVC, the adaptive loop filter 112 is performed over the reconstructed LCU, which smoothes the block boundaries and minimizes the coding distortion between the input and output pictures. If the reconstructed pictures are reference pictures, they are stored as temporal references in the reference buffer 116 for future temporal prediction.

Turning now to FIG. 2, a method for using a scan coding pattern during coding of data or media, such as video data, in accordance with an embodiment is shown and indicated generally at 200. In an embodiment, encoder 100 performs at least some functionality of the method 200, for instance in the entropy coding block 106, to apply a scan coding pattern to a two-dimensional matrix (i.e., block) of transform coefficients during intra or inter coding. In another embodiment, a decoder (not shown but that performs the inverse process of the encoder 100) performs at least some functionality of the method 200, for instance in an entropy coding block within the decoder, to apply a scan coding pattern to a bit sequence to generate an N×M matrix of transform coefficients. Method 200 can be implemented with CABAC entropy coding as is used in HEVC or with CAVLC entropy coding as may be used in other video compression techniques.

As implemented with CABAC or CAVLC entropy coding, in accordance with one embodiment, method 200 is used to scan (i.e., for scan coding, meaning to apply a scan coding pattern to) an N×M TU block or matrix of transform coefficients (during encoding) or to a bit sequence (during decoding) for intra coding or inter coding. In accordance with a further embodiment, compatible with either CABAC or CAVLC entropy coding, method 200 is used for level and sign coding of the non-zero transform coefficients during intra coding or inter coding. In yet another embodiment, compatible with CABAC entropy coding, method 200 is used for two-level significance map coding (i.e., coding of a sub-block level (L1) significance map and a coefficient-level (L0) significance map corresponding to a sub-block having at least one non-zero transform coefficient) during intra coding or inter coding. Processing of a plurality of sub-blocks associated with the N×M matrix of transform coefficients (including L0 and L1 significance map coding and level and sign coding within sub-blocks) can be performed in a sub-block coding order between the sub-blocks (and transform coefficient/value sequence within the sub-blocks) along either a forward or inverse direction of the selected scan coding pattern for all embodiments during intra or inter coding.

Turing now to the details of method 200 as performed in the encoder 100 (the method 200 as performed in the decoder is described thereafter), at 202, the entropy coding block receives an N×M matrix of transform coefficients, wherein N is a row width of the matrix and M is a column height of the matrix. How the encoder 100 applies scan coding to the TU of transform coefficients, in accordance with the present teachings, depends on whether (at 204) the encoder is intra coding the corresponding CU or is inter coding the CU. As is stated earlier, such data regarding the coding type accompanies the video data.

Where intra coding is being performed on the CU, the encoder determines (at 224), e.g., from the RQT quadtree, dimensions of the N×M matrix of transform coefficients, which affect the type of scan coding pattern applied to the N×M matrix during entropy coding. As used herein, a scan coding pattern is defined as a pattern that corresponds to an ordered sequence, which, when applied to a two-dimensional N×M matrix of transform coefficients, orders elements (e.g., transform coefficients and significance map values) associated with the N×M matrix into a one-dimensional sequence along a direction of the scan coding pattern and when applied to a bit sequence generate a two-dimensional N×M matrix of transform coefficients with the coding order of sub-blocks within the matrix and the sequence of elements within the sub-blocks ordered along the scan coding pattern.

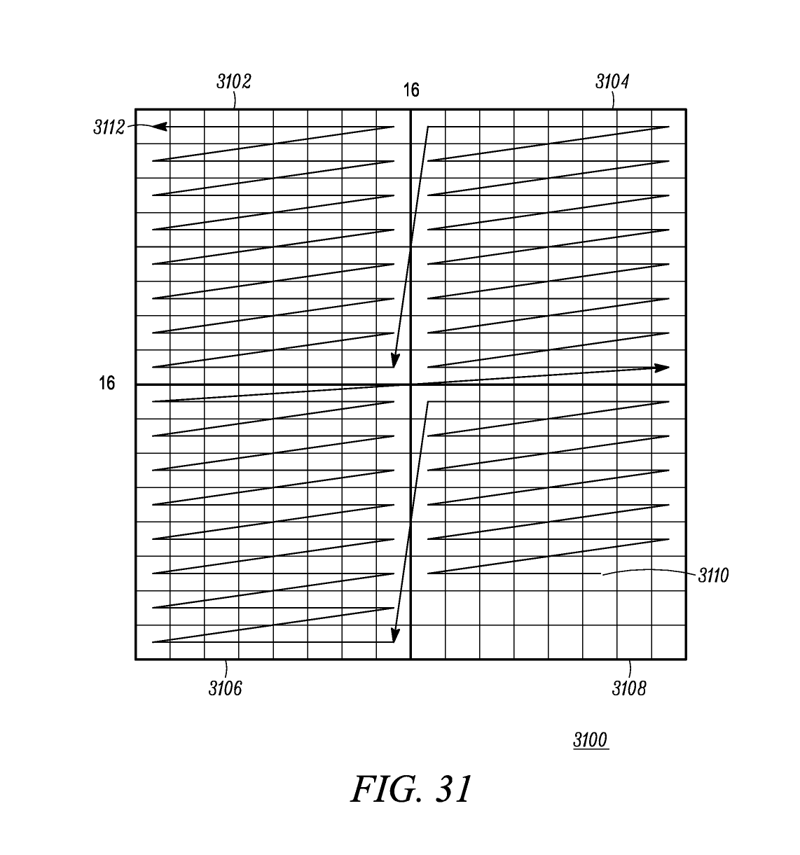

For example, in one embodiment, the elements associated with the N×M matrix of transform coefficients are scan coded along a forward direction of the scan coding pattern, wherein the forward direction of the scan coding pattern starts at an upper left corner of the matrix and proceeds along an ordered sequence of the scan coding pattern toward a lower right corner of the matrix. In another embodiment, the elements associated with the N×M matrix of transform coefficients are scan coded along an inverse (or reverse) direction of the scan coding pattern, wherein the inverse direction of the scan coding pattern starts at the first non-zero element from the lower right corner of the matrix (i.e., starts at the last non-zero element along the forward scan direction or the “last significant position,” see e.g., FIG. 31) and proceeds along the ordered sequence of the scan coding pattern toward the upper left corner of the matrix.

Whether the coding is along the forward or inverse direction of the scan coding pattern is, for example, determined by the particular video compression standard or mechanism being implemented in the encoder and decoder. In an HEVC encoder and decoder implementation, entropy coding is along an inverse direction of the selected scan coding pattern during both the encoding process and the decoding process. Moreover, most of the FIGs. are described as having the inverse scan coding (i.e., application of the scan coding pattern along an inverse direction) start at an element position corresponding to the lower right corner of the matrix being coded. In an embodiment (e.g., a HEVC embodiment), the inverse scan coding starts at a position of the matrix (from the lower right corner) corresponding to the first non-zero element being coded (see e.g., FIG. 31). Application of the scan coding pattern along a forward direction is also referred to herein as forward scan coding.

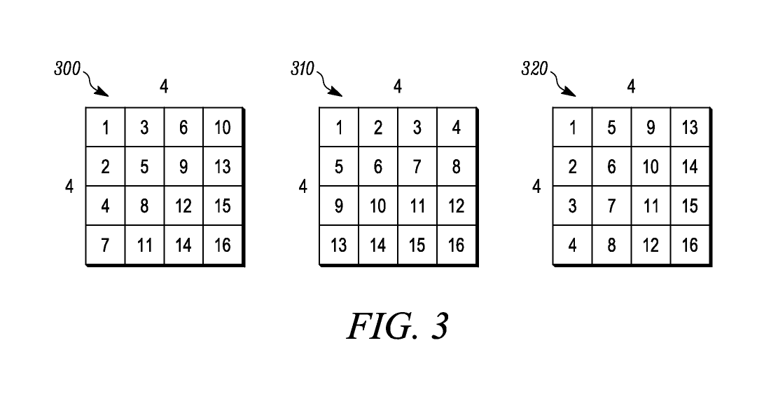

More particularly, the encoder determines (at 206) whether the N×M matrix of transform coefficients has dimensions of 4×4 or 8×8. If yes, the encoder selects (at 208) a scan coding pattern based on an intra prediction direction associated with the N×M matrix of transform coefficients. In an embodiment, compatible with HEVC, when N=M=4 or N=M=8, the encoder selects or determines a first scan coding pattern (at 208) from a set of scan coding patterns that includes a diagonal scan coding pattern (in HEVC a wavefront scan coding pattern), a horizontal scan coding pattern, or a vertical scan coding pattern based on the intra prediction direction associated with the N×M matrix of transform coefficients. The relationship or mapping between the intra prediction direction and the scan coding pattern applied to the N×M matrix is stored, in one embodiment, in a table accessible to the encoder and decoder. For example, the table contains index values each corresponding to an intra prediction angle, wherein the index is used to determine or select the scan coding pattern for the 4×4 TU block or the 8×8 TU block.

Where (at 210), the dimensions of the N×M matrix of transform coefficients is 4×4, the entropy coding block applies the selected scan coding pattern to the 4×4 matrix to, thereby, (at 214) code the N×M matrix of transform coefficients along the forward or the reverse direction of the selected scan coding pattern. This includes level and sign coding the non-zero transform coefficients within the 4×4 TU and coding the values of a 4×4 coefficient-level significance map corresponding to the 4×4 TU transform coefficients. FIG. 3 illustrates application of wavefront (300), horizontal (310), and vertical (320) scan coding patterns to a 4×4 matrix in accordance with one embodiment. In this illustrative implementation, the particular scan coding pattern 300, 310, or 320 applied to the 4×4 TU of transform coefficients depends on the intra prediction direction associated with the TU of transform coefficients.

Each scan coding pattern 300, 310, 320 orders the elements of a two-dimensional 4×4 block of elements (e.g., two-dimensional TU block or a 4×4 sub-block within a larger partitioned TU block) into a one dimensional sequence along the direction of the numerical sequence 1-16 shown in the scan coding patterns. Namely, the forward direction of each scan coding pattern 300, 310, 320 starts at number 1 of the numerical sequence in the upper left corner of the scan coding pattern and proceeds along the numerical sequence from 1 to 16 until reaching number 16 in the lower right corner of the scan coding pattern, in one embodiment. Whereas, the inverse direction of each scan coding pattern 300, 310, 320 starts at number 16 of the numerical sequence in the lower right corner of the scan coding pattern (or starts at the last non-zero element from position 16) and proceeds along the reverse direction of the numerical sequence from 16 (or from the last non-zero element from position 16) until reaching number 1 in the upper left corner of the scan coding pattern. As can be seen, the manner in which elements of the N×M block are sequenced from 1 to 16 or from 16 to 1 depends on the particular scan coding pattern 300, 310, 320 selected.

As used herein, a diagonal scan coding pattern orders elements of a two-dimensional matrix along a diagonal direction within the matrix. A wavefront (diagonal) scan coding pattern and a zigzag (diagonal) scan coding pattern are both examples of diagonal scan coding patterns. A wavefront scan coding pattern (also referred to in the HEVC specification as an up-right diagonal scan) is defined as a scan coding pattern that orders elements of a block along a same diagonal direction either all top-right in the forward direction or all down-left in an inverse direction; whereas the direction of the zigzag scan coding pattern alternates between up and down. A horizontal scan coding pattern is defined a scan coding pattern that orders elements of a block from the left to the right per row and from the top row to the bottom row in a forward direction and that orders the elements of a block from the right to the left per row and from the bottom row to the top row in an inverse direction. A vertical scan coding pattern is defined a scan coding pattern that orders elements of a block from the top to the bottom per column and from the left column to the right column in the forward direction and that orders the elements of a block from the bottom to the top per column and from the right column to the left column in an inverse direction.

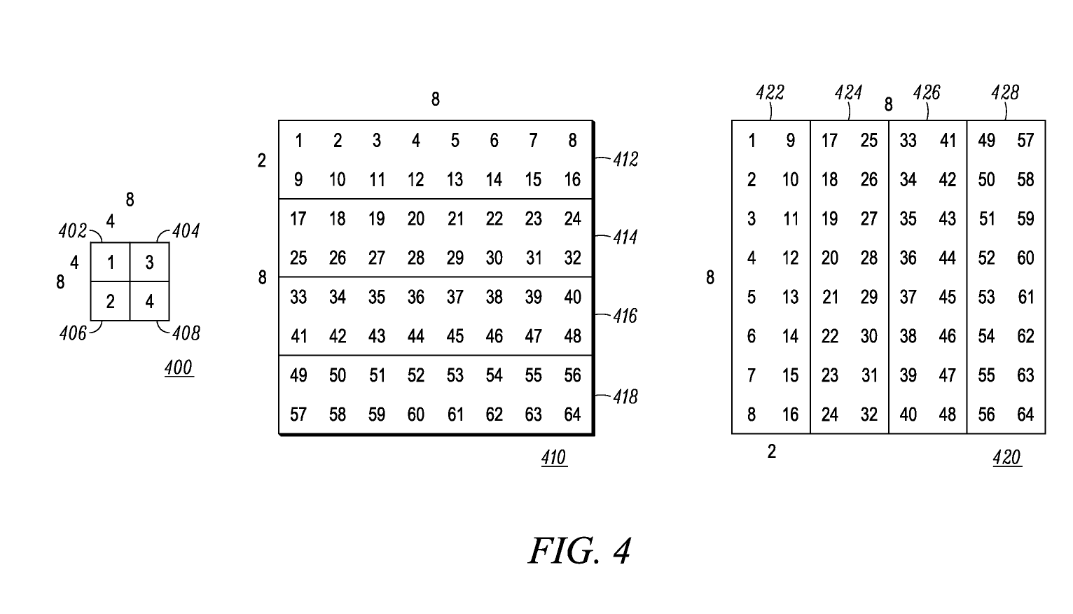

Turning back to method 200, at 210, where the N×M intra block has 8×8 dimensions, the encoder 100 partitions the N×M matrix of elements (at 212) into multiple sub-blocks, each comprising a plurality of the elements, before processing the plurality of sub-blocks (at 220), one at a time, in a coding order along the selected (first) scan coding pattern to generate a bit sequence corresponding to the TU of transform coefficients. The coding (and decoding) order (also referred to herein as the scan coding order) is defined as the sequential processing order for the sub-blocks associated with a block. In this case, how the matrix is partitioned depends on the selected scan coding pattern, as can be seen in FIG. 4. Upon partitioning the N×M matrix of transform coefficients into multiple sub-blocks, in accordance with the present teachings, the processing of the N×M matrix comprises multiple components or aspects. Namely, a sub-block level significance map corresponding to the plurality of sub-blocks is generated and coded along the first scan coding pattern. In addition, a coefficient-level significance map corresponding to each sub-block having one or more non-zero transform coefficients is generated and the values within the significance map are coded in a sequence along a second scan coding pattern.

Moreover, for the sub-blocks containing at least one non-zero transform coefficient, the processing comprises (at 222) level and sign coding at least the non-zero transform coefficients in a transform coefficient sequence along the second scan coding pattern. The transform coefficient sequence is defined as the sequential processing order for the transform coefficients within the sub-block. In one embodiment (as is consistent with HEVC), the first and second scan coding patterns comprise a same type of scan coding pattern. In an alternative embodiment, the first and second scan coding patterns comprise a different type of scan coding pattern.

As stated earlier, how the matrix is partitioned depends on the selected scan pattern, as illustrated in FIG. 4. More particularly, FIG. 4 illustrates wavefront (400), horizontal (410), and vertical (420) scan coding patterns used to order elements of an 8×8 matrix (e.g., a TU block, wherein N=M=8) in accordance with an embodiment. In accordance with this embodiment, when the selected scan coding pattern is the wavefront scan coding pattern 400, the plurality of sub-blocks (of the N×M matrix of transform coefficients) comprises four 4×4 sub-blocks 402, 404, 406, and 408. Moreover, in one embodiment, the scan coding order of the 4×4 sub-blocks comprises processing the bottom right sub-block 408, followed by the top right sub-block 404, followed by the bottom left sub-block 406, followed by the top left sub-block 402, whereby the scan coding order of the sub-blocks is along the inverse direction of the wavefront scan coding pattern. In this case, the elements within each of the four 4×4 sub-blocks, 402, 404, 406, and 408, are entropy coded along the inverse direction of the selected wavefront scan coding pattern, as illustrated and described by reference to pattern 300 of FIG. 3.

In another embodiment, the scan coding order of the 4×4 sub-blocks comprises processing the top left sub-block, followed by the bottom left sub-block followed by the top right sub-block, followed by the bottom right sub-block, whereby the scan coding order of the sub-blocks is along the forward direction of the wavefront scan coding pattern. In this case, the elements within each of the four 4×4 sub-blocks, 402, 404, 406, and 408, are entropy coded along the forward direction of the selected wavefront scan coding pattern, as illustrated and described by reference to pattern 300 of FIG. 3.

When the selected scan coding pattern is the horizontal scan coding pattern 410, the plurality of sub-blocks (of the 8×8 matrix of elements) comprises four 8×2 sub-blocks 412, 414, 416, and 418, wherein 8 is a row width of each sub-block and 2 is a column height of each sub-block. In one embodiment, the scan coding order of the sub-blocks 412, 414, 416, and 418 comprises processing the sub-blocks from the bottom sub-block 418 to the top sub-block 412, whereby the scan coding order of the sub-blocks is along the inverse direction of the horizontal scan coding pattern. Entropy coding the elements within the sub-blocks along the inverse direction of the horizontal scan coding pattern proceeds from number (element) 64 in a reverse numerical sequence to number (element) 1 of the 8×8 matrix. In another embodiment, the scan coding order of the sub-blocks 412, 414, 416, and 418 comprises processing the sub-blocks from the top sub-block 412 to the bottom sub-block 418, whereby the scan coding order of the sub-blocks is along the forward direction of the horizontal scan coding pattern. Entropy coding the elements within the sub-blocks along the forward direction of the horizontal scan coding pattern proceeds from number (element) 1 in a forward numerical sequence to number (element) 64 of the 8×8 matrix.

When the selected scan coding pattern is the vertical scan coding pattern 420, the plurality of sub-blocks (of the 8×8 matrix of elements) comprises four 2×8 sub-blocks 422, 424, 426, and 428, wherein 2 is a row width of each sub-block and 8 is a column height of each sub-block. In one embodiment, the scan coding order of the sub-blocks 422, 424, 426, and 428 comprises processing the sub-blocks from the right sub-block 428 to the left sub-block 422, whereby the scan coding order of the sub-blocks is along the inverse direction of the vertical scan coding pattern. Entropy coding the elements within the sub-blocks along the inverse direction of the vertical scan coding pattern proceeds from number (element) 64 in a reverse numerical sequence to number (element) 1 of the 8×8 matrix. In another embodiment, the scan coding order of the sub-blocks 422, 424, 426, and 428 comprises processing the sub-blocks from the left sub-block 422 to the right sub-block 428, whereby the scan coding order of the sub-blocks is along the forward direction of the vertical scan coding pattern. Entropy coding the elements within the sub-blocks along the forward direction of the vertical scan coding pattern proceeds from number (element) 1 in a forward numerical sequence to number (element) 64 of the 8×8 matrix.

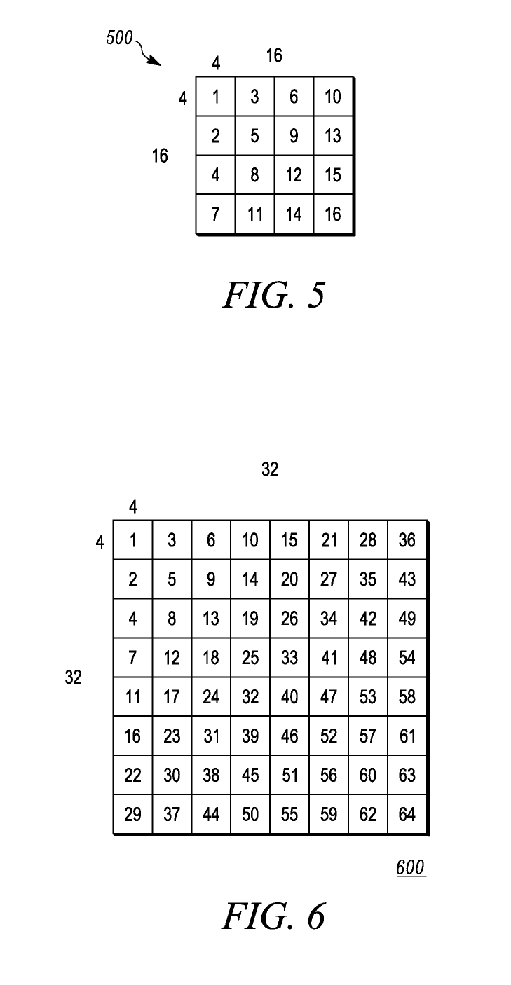

Turning back to decision diamond 206 of method 200, when the dimensions of the (received) N×M matrix of elements is greater than 8×8 (in this case N=M and N and M are greater than 8), the selected (at 216) scan coding pattern is the wavefront scan coding pattern. In one embodiment, the wavefront scan coding pattern is applied to code a 16×16 matrix of transform coefficients as illustrated at 500 in FIG. 5. In another embodiment, the wavefront scan coding pattern is applied to code a 32×32 matrix of transform coefficients as illustrated at 600 in FIG. 6. In both of these embodiments, the matrix of elements is partitioned (at 218) into a plurality of 4×4 sub-blocks.

As shown by reference to FIG. 5, the 16×16 matrix is partitioned into 16 4×4 sub-blocks. In one embodiment, the scan coding order of the sub-blocks 1-16 comprises processing the sub-blocks in reverse numerical sequence from 16 to 1, whereby the scan coding order of the sub-blocks is along the inverse direction of the wavefront scan coding pattern. In this case, the elements within each of the sub-blocks 1-16 are entropy coded along the inverse direction of the selected wavefront scan coding pattern, as illustrated and described by reference to pattern 300 of FIG. 3. In another embodiment, the scan coding order of the sub-blocks 1-16 comprises processing the sub-blocks in numerical sequence from 1 to 16, whereby the scan coding order of the sub-blocks is along the forward direction of the wavefront scan coding pattern. In this case, the elements within each of the sub-blocks 1-16 are entropy coded along the forward direction of the selected wavefront scan coding pattern, as illustrated and described by reference to pattern 300 of FIG. 3.

As shown by reference to FIG. 6, the 32×32 matrix is partitioned into 64 4×4 sub-blocks. In one embodiment, the scan coding order of the sub-blocks 1-64 comprises processing the sub-blocks in reverse numerical sequence from 64 to 1, whereby the scan coding order of the sub-blocks is along the inverse direction of the wavefront scan coding pattern. In this case, the elements within each of the sub-blocks 1-64 are entropy coded along the inverse direction of the selected wavefront scan coding pattern, as illustrated and described by reference to pattern 300 of FIG. 3. In another embodiment, the scan coding order of the sub-blocks 1-64 comprises processing the sub-blocks in numerical sequence from 1 to 64, whereby the scan coding order of the sub-blocks is along the forward direction of the wavefront scan coding pattern. In this case, the elements within each of the sub-blocks 1-64 are entropy coded along the forward direction of the selected wavefront scan coding pattern, as illustrated and described by reference to pattern 300 of FIG. 3.

Turning again to decision block 204 of method 200, where inter coding is performed on the CU, the encoder determines (at 226), e.g., from the RQT quadtree, dimensions of the N×M matrix of transform coefficients, which affect how a selected scan coding pattern is applied to the N×M matrix during entropy coding. If the encoder determines (at 228) that the dimensions of the N×M matrix of transform coefficients are 4×4, the entropy coding block selects the wavefront scan coding pattern and applies the selected scan coding pattern to the 4×4 matrix as illustrated and described by reference to scan coding pattern 300 (of FIG. 3) to, thereby, (at 230) entropy code the elements within the 4×4 matrix in a sequence along the forward or the reverse direction of the selected scan coding pattern.

Where the encoder determines (at 228) that the N×M matrix is larger than 4×4 (in this case, N=M and N and M are larger 4), the selected (at 216) first scan coding pattern is a first diagonal (e.g., wavefront) scan coding pattern. In one embodiment, the wavefront scan coding pattern is applied to an 8×8 matrix of elements as described in detail above and illustrated by reference to the wavefront scan coding pattern 400 of FIG. 4. In another embodiment, the wavefront scan coding pattern is applied to a 16×16 matrix of elements as described in detail above and illustrated by reference to the wavefront scan coding pattern 500 of FIG. 5. In another embodiment, the wavefront scan coding pattern is applied to a 32×32 matrix of elements as described in detail above and illustrated by reference to the wavefront scan coding pattern 600 of FIG. 6. In all of these embodiments, the N×M matrix of elements is partitioned (at 218) into a plurality of 4×4 sub-blocks each comprising a plurality of the elements, before processing the plurality of sub-blocks (at 220), one at a time, in a coding order along the first diagonal scan coding pattern to generate a bit sequence corresponding to the TU of transform coefficients.

Upon partitioning the N×M matrix of transform coefficients into multiple 4×4 sub-blocks in accordance with the present teachings, the processing (coding) of the N×M matrix comprises multiple components or aspects (222). Namely, processing the plurality of sub-blocks comprises two-level significance map coding. More particularly, a sub-block level significance map corresponding to the plurality of sub-blocks is generated and coded along the first diagonal scan coding pattern. In addition, a coefficient-level significance map corresponding to each sub-block having one or more non-zero transform coefficients is generated and the values within the significance map are coded in a sequence along a second diagonal scan coding pattern. Moreover, for the sub-blocks containing at least one non-zero transform coefficient, the processing comprises (at 222) level and sign coding at least the non-zero transform coefficients in a transform coefficient sequence along the second diagonal scan coding pattern. In one embodiment (as is consistent with HEVC), the first and second scan coding patterns comprise a same type of scan coding pattern, namely, a wavefront scan coding pattern. In an alternative embodiment, the first and second scan coding patterns comprise a different type of scan coding pattern.

As mentioned above, a decoder (not shown but that performs the inverse process of the encoder 100) performs at least some functionality of the method 200 in an entropy decoding block within the decoder. The method 200 is as described above for intra and inter coding, except that the decoder performs the method 200 to generate or build (from a received bit sequence) an N×M matrix of transform coefficients comprising multiple sub-blocks each having a plurality of the transform coefficients.

The decoder, in accordance with the present teachings includes an entropy decoding block, which performs the inverse algorithm as the entropy encoding block 106 of the encoder. The decoder further includes the same elements as performs the decoding process within the encoder 100, which receives the quantized transform coefficients from the entropy coding block and generates the TUs and the pictures of video. Namely, the decoding process within the decoder further includes the dequantizer 108, the inverse transform 110, the loop filter 112, the spatial prediction block 114, the reference buffer 116, the temporal prediction block 118, and the switch 120 that function as described above.

Accordingly, in one embodiment, the decoder performs method 200 for entropy coding a bit sequence along a scan coding pattern during decoding of data (e.g., video data) to generate intra frames. The decoder receives, during intra coding, a bit sequence corresponding to an N×M matrix of transform coefficients, wherein N is a row width of the matrix and M is a column height of the matrix. The decoder then processes the bit sequence to generate a plurality of sub-blocks each comprising a plurality of the transform coefficients, wherein the sub-blocks are generated, one at a time, in a decoding order along a first scan coding pattern to form the N×M matrix of transform coefficients, wherein the first scan coding pattern is determined from a set of scan coding patterns comprising a diagonal scan coding pattern, a horizontal scan coding pattern, and a vertical scan coding pattern.

The processing further includes, for the sub-blocks containing at least one non-zero transform coefficient, decoding a portion of the bit sequence to generate the transform coefficients in a transform coefficient sequence along a second scan coding pattern. Moreover, the processing includes coding a sub-block level significance map and a coefficient-level significance map corresponding each sub-block containing at least one non-zero transform coefficient. When N=M and N and M are greater than 8, the first and second scan coding patterns comprise (in an HEVC implementation) a wavefront diagonal scan coding pattern; each sub-block has dimensions of 4×4; and inverse scan coding is performed.

Where N=M=8, the first scan coding pattern is determined based on an intra prediction direction associated with the N×M block of transform coefficients. Where the first scan coding pattern is the vertical scan coding pattern, the plurality of sub-blocks comprises four 2×8 sub-blocks, wherein 2 is a row width of each sub-block and 8 is a column height of each sub-block, and the decoding order of the 2×8 sub-blocks is from right to left or from left to right. Where the first scan coding pattern is the horizontal scan coding pattern, the plurality of sub-blocks comprises four 8×2 sub-blocks, wherein 8 is a row width of each sub-block and 2 is a column height of each sub-block, and the decoding order of the 8×2 sub-blocks is from bottom to top or from top to bottom. Moreover, where the first scan coding pattern is a wavefront diagonal scan coding pattern, the plurality of sub-blocks comprises four 4×4 sub-blocks, and the decoding order of the 4×4 sub-blocks starts with a bottom right sub-block, followed by a top right sub-block, followed by a bottom left sub-block, followed by a top left sub-block or starts with the top left sub-block, followed by the bottom left sub-block followed by the top right sub-block, followed by the bottom right sub-block. In one embodiment (as is consistent with HEVC), the first and second scan coding patterns comprise a same type of scan coding pattern. In an alternative embodiment, the first and second scan coding patterns comprise a different type of scan coding pattern.

In accordance with another embodiment, the decoder performs method 200 for entropy coding a bit sequence along a scan coding pattern during decoding of data (e.g., video data) to generate inter frames. The decoder receives, during inter coding, a bit sequence corresponding to an N×M matrix of transform coefficients, wherein N is a row width of the matrix and M is a column height of the matrix. The decoder then processes the bit sequence to generate a plurality of sub-blocks each comprising a plurality of the transform coefficients, wherein the sub-blocks are generated, one at a time, in a decoding order along a first diagonal scan coding pattern to form the N×M matrix of transform coefficients.

Processing the bit sequence, for the sub-blocks containing at least one non-zero transform coefficient, further includes decoding a portion of the bit sequence to generate the transform coefficients in a transform coefficient sequence along a second diagonal scan coding pattern. Moreover, the processing includes coding a sub-block level significance map and a coefficient-level significance map corresponding to each sub-block having at least one non-zero transform coefficient. When N=M and N and M are equal to or greater than 8, the first and second diagonal scan coding patterns comprise (in an HEVC implementation) a wavefront diagonal scan coding pattern; each sub-block has dimensions of 4×4; and inverse scan coding is performed.

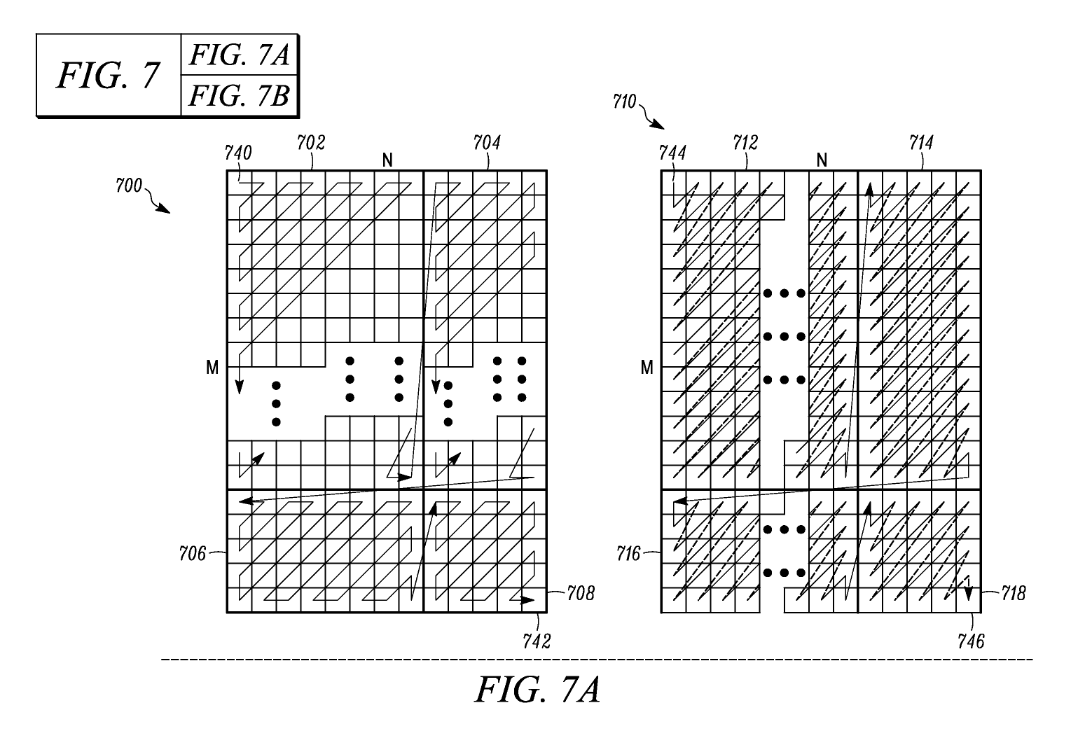

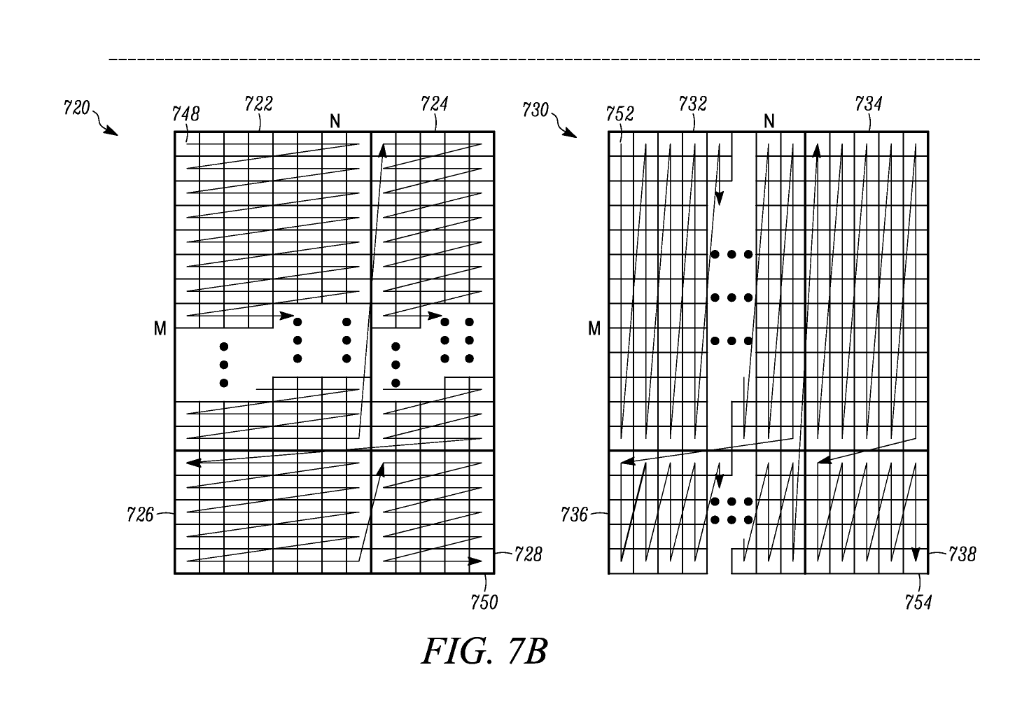

FIGS. 2-6 illustrate one example implementation of the present teachings, which is compatible with HEVC. However, numerous additional examples of applying a scan coding pattern to an N×M matrix during coding, in accordance with the present teachings, are feasible. Multiple such examples include, but are not limited to, those provided and described by reference to the remaining FIGS. 7-37. The embodiments described and illustrated by reference to FIGS. 7-37 can be applied, for example: during intra coding or inter coding of video or other data; during the encoding or decoding process; with CABAC or CAVLC entropy coding or other entropy coding techniques; along a forward or an inverse direction of a selected scan coding pattern; for significance map and levels and sign coding; and for two-levels coding, e.g., L0 coding and L1 coding, of significance maps.

In general, in accordance with these additional example implementations, during encoding of an N×M matrix of transform coefficients, wherein N is a row width of the matrix and M is a column height of the matrix, the matrix is partitioned into a small number of sub-blocks (e.g., two or four) and each of the sub-blocks are processed one block at a time in a coding order along a direction of a selected scan coding pattern. Processing each sub-block comprises entropy coding the elements within the sub-block along the direction of the selected scan coding pattern to generate a corresponding bit sequence.

Moreover in general, in accordance with these additional example implementations, during decoding of a bit sequence corresponding to data such as video data, the bit sequence is processed to generate an N×M matrix (e.g., transform unit block) comprising multiple sub-blocks each having a plurality of transform coefficients corresponding to a portion of the video data, wherein N is a row width of the transform unit block and M is a column height of the transform unit block. Processing the bit sequence comprises generating the multiple sub-blocks one at a time in a coding order along a direction of a selected scan coding pattern. Generating each sub-block comprises entropy coding a portion of the bit sequence to determine the plurality of transform coefficients within the sub-block in a transform coefficient order along the direction of the selected scan coding pattern.

Turning now to the details of the remaining FIGS. 7-27. FIG. 7 (i.e., collectively 7A and 7B) illustrates using zigzag, wavefront, horizontal, and vertical scan coding patterns in accordance with an embodiment. A zigzag scan coding pattern is applied to an N×M matrix of elements 700. In accordance with the present teachings, during encoding, the matrix 700 is partitioned into (or, during decoding, the matrix 700 is generated having) four sub-blocks 702, 704, 706, 708. The sub-blocks are processed in a scan coding order 702, 704 (or 706), 706 (or 704), and 708 along a forward direction of the scan coding pattern or in a scan coding order 708, 706 (or 704), 704 (or 706), and 702 along an inverse direction of the scan coding pattern. Processing each sub-block comprises entropy coding the elements (e.g., transform coefficients or significance map values) of (i.e., associated with) the sub-block along the direction of the zigzag scan coding pattern. A forward direction for entropy coding along the scan coding pattern starts with an element at position 740 of the matrix 700 and follows a sequence corresponding to the forward direction of the arrowed lines until reaching an element at position 742 of the matrix 700. An inverse direction for entropy coding along the scan coding pattern starts with the element at position 742 of the matrix 700 and follows a sequence corresponding to the reverse direction of the arrowed lines until reaching the element at position 740 of the matrix 700.

In further accordance with FIG. 7, a wavefront scan coding pattern is applied to an N×M matrix of elements 710. In accordance with the present teachings, during encoding, the matrix 710 is partitioned into (or, during decoding, the matrix 710 is generated having) four sub-blocks 712, 714, 716, 718. The sub-blocks are processed in a scan coding order 712, 714 (or 716), 716 (or 714), and 718 along a forward direction of the scan coding pattern or in a scan coding order 718, 716 (or 714), 714 (or 716), and 712 along an inverse direction of the scan coding pattern. Processing each sub-block comprises entropy coding the elements of the sub-block along the direction of the wavefront scan coding pattern. A forward direction for entropy coding along the scan coding pattern starts with an element at position 744 of the matrix 710 and follows a sequence corresponding to the forward direction of the arrowed lines until reaching an element at position 746 of the matrix 710. An inverse direction for entropy coding along the scan coding pattern starts with the element at position 746 of the matrix 710 and follows a sequence corresponding to the reverse direction of the arrowed lines until reaching the element at position 744 of the matrix 710.

In further accordance with FIG. 7, a horizontal scan coding pattern is applied to an N×M matrix of elements 720. In accordance with the present teachings, during encoding, the matrix 720 is partitioned into (or, during decoding, the matrix 720 is generated having) four sub-blocks 722, 724, 726, 728. The sub-blocks are processed in a scan coding order 722, 724, 726, and 728 along a forward direction of the scan coding pattern or in a scan coding order 728, 726, 724, and 722 along an inverse direction of the scan coding pattern. Processing each sub-block comprises entropy coding the elements of the sub-block along the direction of the horizontal scan coding pattern. A forward direction for entropy coding along the scan coding pattern starts with an element at position 748 of the matrix 720 and follows a sequence corresponding to the forward direction of the arrowed lines until reaching an element at position 750 of the matrix 720. An inverse direction for entropy coding along the scan coding pattern starts with the element at position 750 of the matrix 720 and follows a sequence corresponding to the reverse direction of the arrowed lines until reaching the element at position 748 of the matrix 720.

In further accordance with FIG. 7, a vertical scan coding pattern is applied to an N×M matrix of elements 730. In accordance with the present teachings, during encoding, the matrix 730 is partitioned into (or, during decoding, the matrix 730 is generated having) four sub-blocks 732, 734, 736, 738. The sub-blocks are processed in a scan coding order 732, 736, 734, and 738 along a forward direction of the scan coding pattern or in a scan coding order 738, 734, 736, and 732 along an inverse direction of the scan coding pattern. Processing each sub-block comprises entropy coding the elements of the sub-block along the direction of the vertical scan coding pattern. A forward direction for entropy coding along the scan coding pattern starts with an element at position 752 of the matrix 730 and follows a sequence corresponding to the forward direction of the arrowed lines until reaching an element at position 754 of the matrix 730. An inverse direction for entropy coding along the scan coding pattern starts with the element at position 754 of the matrix 730 and follows a sequence corresponding to the reverse direction of the arrowed lines until reaching the element at position 752 of the matrix 730.

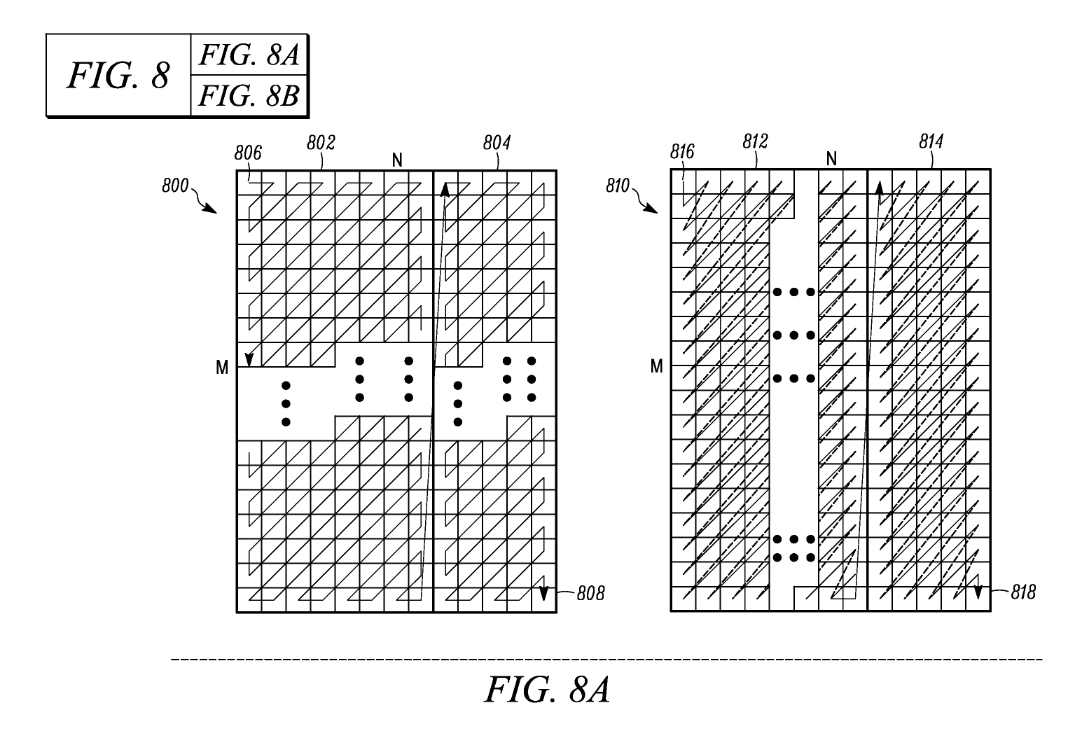

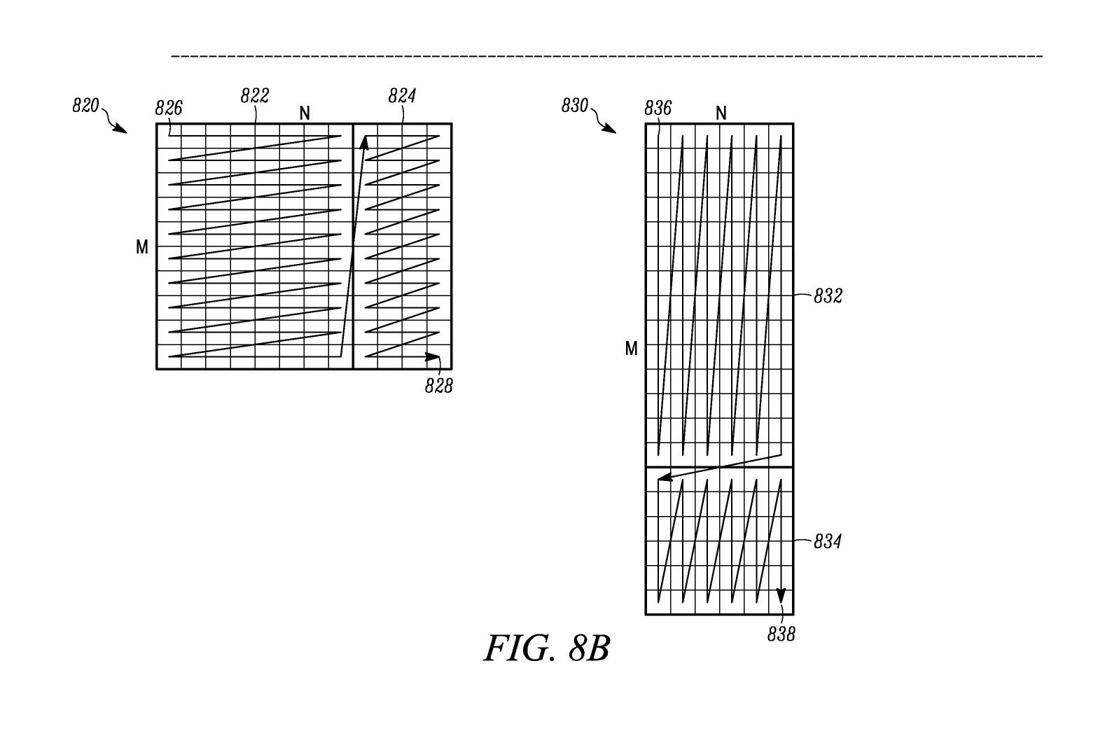

FIG. 8 (i.e., collectively 8A and 8B) illustrates zigzag, wavefront, horizontal, and vertical scan coding patterns in accordance with an embodiment. A zigzag scan coding pattern is applied to an N×M matrix of elements 800. In accordance with the present teachings, during encoding, the matrix 800 is partitioned into (or, during decoding, the matrix 800 is generated having) two sub-blocks 802 and 804. The sub-blocks are processed in a scan coding order 802, 804 along a forward direction of the scan coding pattern or in a scan coding order 804, and 802 along an inverse direction of the scan coding pattern. Processing each sub-block comprises entropy coding the elements of the sub-block along the direction of the zigzag scan coding pattern. A forward direction for entropy coding along the scan coding pattern starts with an element at position 806 of the matrix 800 and follows a sequence corresponding to the forward direction of the arrowed lines until reaching an element at position 808 of the matrix 800. An inverse direction for entropy coding along the scan coding pattern starts with the element at position 808 of the matrix 800 and follows a sequence corresponding to the reverse direction of the arrowed lines until reaching the element at position 806 of the matrix 800.

In further accordance with FIG. 8, a wavefront scan coding pattern is applied to an N×M matrix of elements 810. In accordance with the present teachings, during encoding, the matrix 810 is partitioned into (or, during decoding, the matrix 810 is generated having) two sub-blocks 812 and 814. The sub-blocks are processed in a scan coding order 812, 814 along a forward direction of the scan coding pattern or in a scan coding order 814, and 812 along an inverse direction of the scan coding pattern. Processing each sub-block comprises entropy coding the elements of the sub-block along the direction of the wavefront scan coding pattern. A forward direction for entropy coding along the scan coding pattern starts with an element at position 816 of the matrix 810 and follows a sequence corresponding to the forward direction of the arrowed lines until reaching an element at position 818 of the matrix 710. An inverse direction for entropy coding along the scan coding pattern starts with the element at position 818 of the matrix 810 and follows a sequence corresponding to the reverse direction of the arrowed lines until reaching the element at position 816 of the matrix 810.

In further accordance with FIG. 8, a horizontal scan coding pattern is applied to an N×M matrix of elements 820. In accordance with the present teachings, during encoding, the matrix 820 is partitioned into (or, during decoding, the matrix 820 is generated having) four sub-blocks 822 and 824. The sub-blocks are processed in a scan coding order 822, 824 along a forward direction of the scan coding pattern or in a scan coding order 824, 822 along an inverse direction of the scan coding pattern. Processing each sub-block comprises entropy coding the elements of the sub-block along the direction of the horizontal scan coding pattern. A forward direction for entropy coding along the scan coding pattern starts with an element at position 826 of the matrix 820 and follows a sequence corresponding to the forward direction of the arrowed lines until reaching an element at position 828 of the matrix 820. An inverse direction for entropy coding along the scan coding pattern starts with the element at position 828 of the matrix 820 and follows a sequence corresponding to the reverse direction of the arrowed lines until reaching the element at position 826 of the matrix 820.

In further accordance with FIG. 8, a vertical scan coding pattern is applied to an N×M matrix of elements 830. In accordance with the present teachings, during encoding, the matrix 830 is partitioned into (or, during decoding, the matrix 830 is generated having) two sub-blocks 832 and 834. The sub-blocks are processed in a scan coding order 832, 834 along a forward direction of the scan coding pattern or in a scan coding order 834, 832 along an inverse direction of the scan coding pattern. Processing each sub-block comprises entropy coding the elements of the sub-block along the direction of the vertical scan coding pattern. A forward direction for entropy coding along the scan coding pattern starts with an element at position 836 of the matrix 830 and follows a sequence corresponding to the forward direction of the arrowed lines until reaching an element at position 838 of the matrix 830. An inverse direction for entropy coding along the scan coding pattern starts with the element at position 838 of the matrix 830 and follows a sequence corresponding to the reverse direction of the arrowed lines until reaching the element at position 836 of the matrix 830.

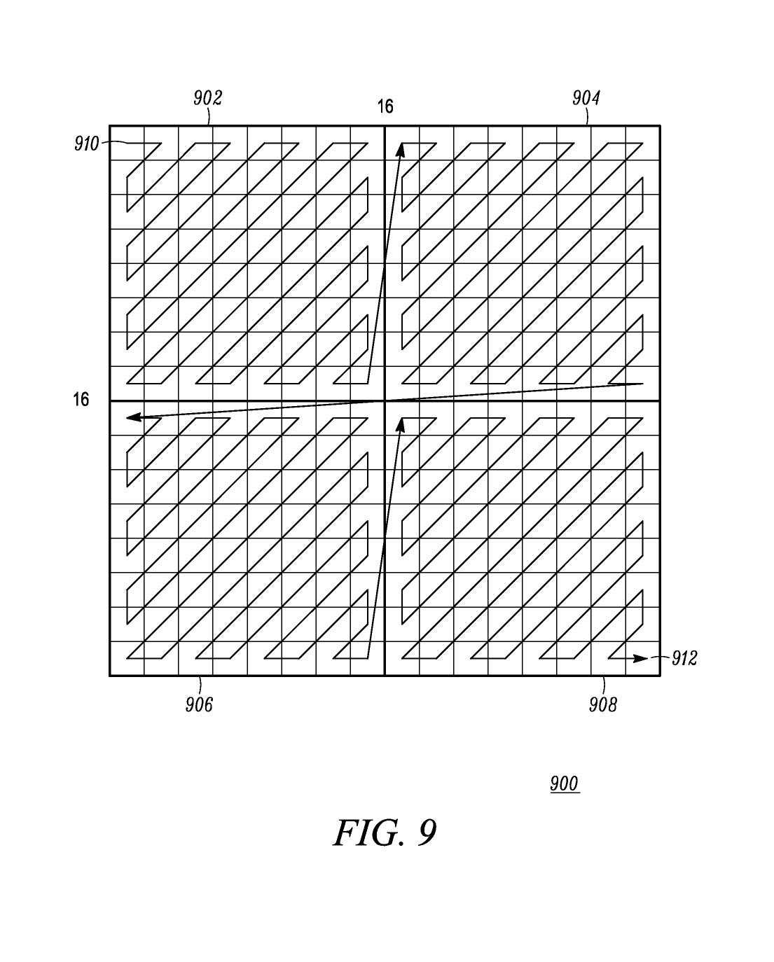

FIG. 9 illustrates a zigzag scan coding pattern applied to a 16×16 matrix of elements 900 in accordance with an embodiment. During encoding, the matrix 900 is partitioned into (or, during decoding, the matrix 900 is generated having) four sub-blocks 902, 904, 906, 908. Forward scan coding between and within the sub-blocks is performed along a forward direction of the arrowed lines from an element position 910 to an element position 912 within the matrix 900. Inverse scan coding between and within the sub-blocks is performed along an inverse direction of the arrowed lines from the element position 912 to the element position 910 within the matrix 900.

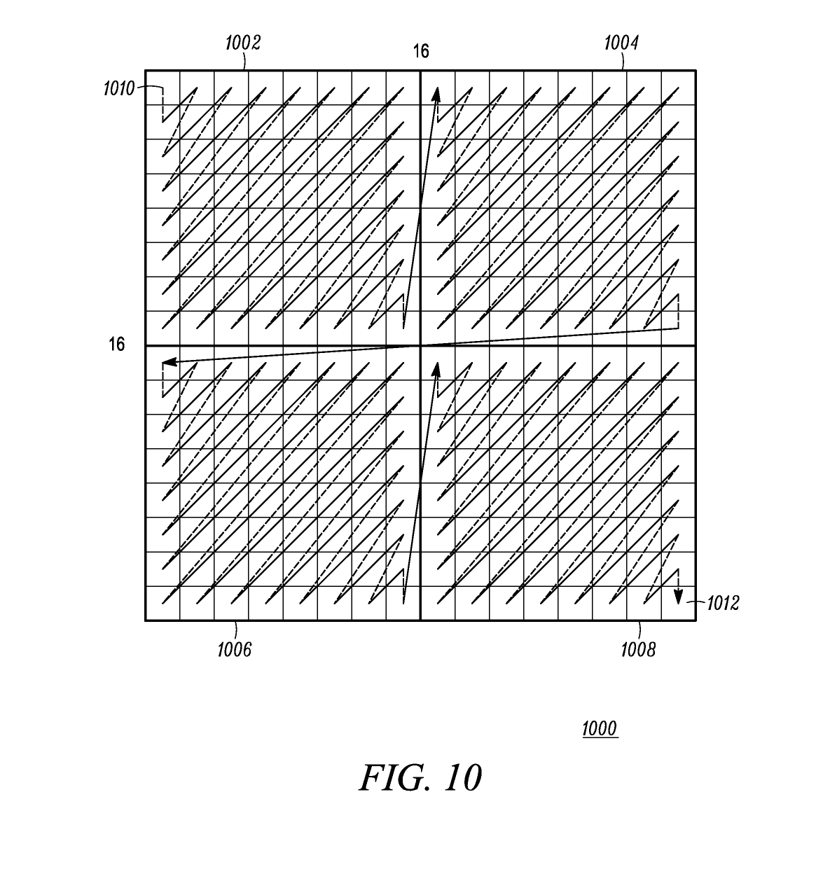

FIG. 10 illustrates a wavefront scan coding pattern applied to a 16×16 matrix of elements 1000 in accordance with an embodiment. During encoding, the matrix 1000 is partitioned into (or, during decoding, the matrix 1000 is generated having) four sub-blocks 1002, 1004, 1006, 1008. Forward scan coding between and within the sub-blocks is performed along a forward direction of the arrowed lines from an element position 1010 to an element position 1012 within the matrix 1000. Inverse scan coding between and within the sub-blocks is performed along an inverse direction of the arrowed lines from the element position 1012 to the element position 1010 within the matrix 1000.

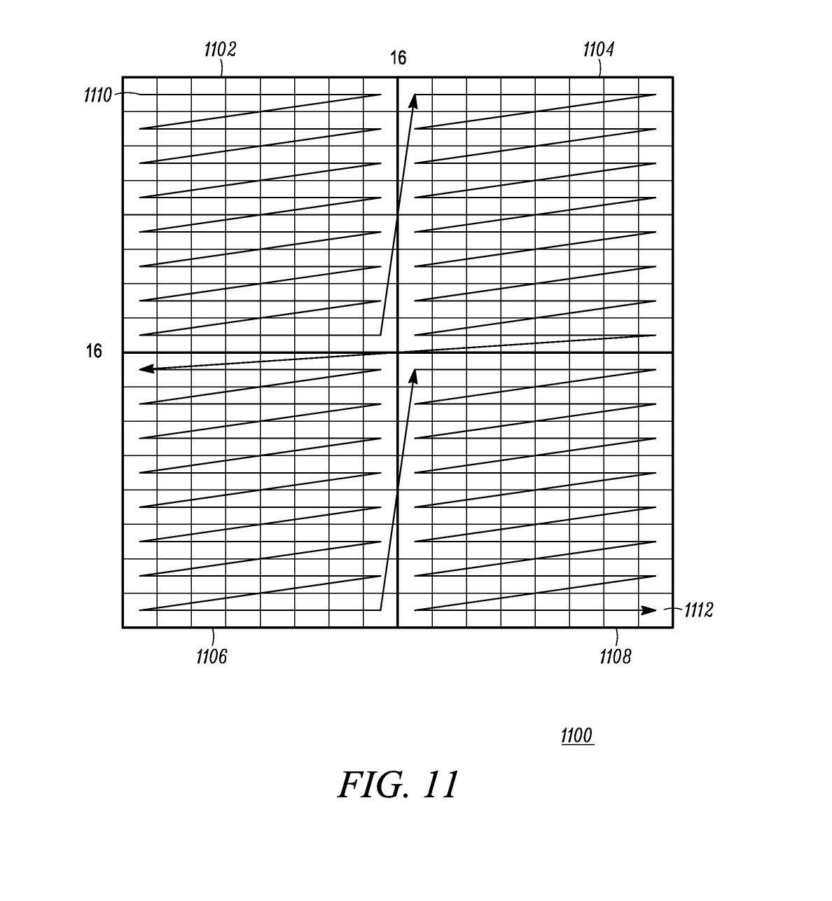

FIG. 11 illustrates a horizontal scan coding pattern applied to a 16×16 matrix of elements 1100 in accordance with an embodiment. During encoding, the matrix 1100 is partitioned into (or, during decoding, the matrix 1100 is generated having) four sub-blocks 1102, 1104, 1106, 1108. Forward scan coding between and within the sub-blocks is performed along a forward direction of the arrowed lines from an element position 1110 to an element position 1112 within the matrix 1100. Inverse scan coding between and within the sub-blocks is performed along an inverse direction of the arrowed lines from the element position 1112 to the element position 1110 within the matrix 1100.

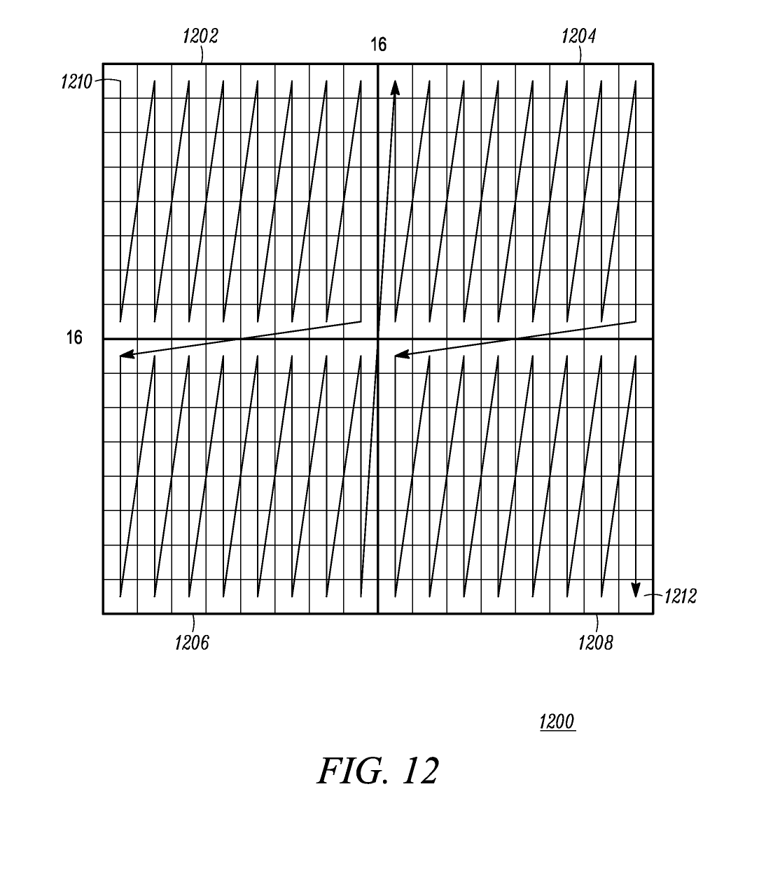

FIG. 12 illustrates a vertical scan coding pattern applied to a 16×16 matrix of elements 1200 in accordance with an embodiment. During encoding, the matrix 1200 is partitioned into (or, during decoding, the matrix 1200 is generated having) four sub-blocks 1202, 1204, 1206, 1208. Forward scan coding between and within the sub-blocks is performed along a forward direction of the arrowed lines from an element position 1210 to an element position 1212 within the matrix 1200. Inverse scan coding between and within the sub-blocks is performed along an inverse direction of the arrowed lines from the element position 1212 to the element position 1210 within the matrix 1200.

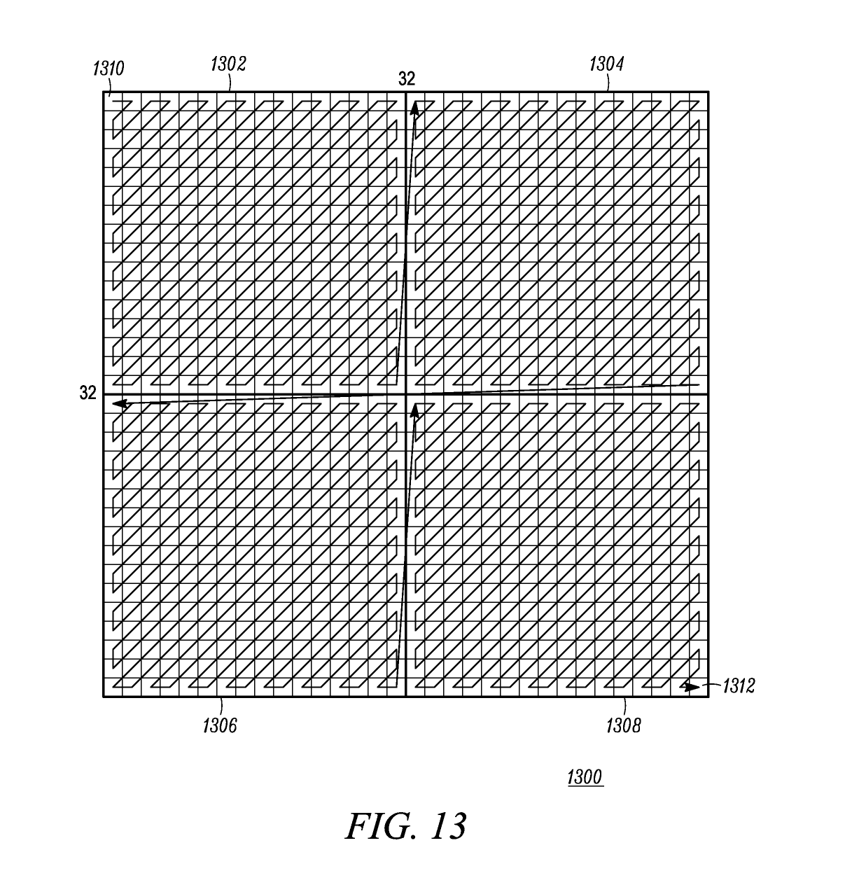

FIG. 13 illustrates a zigzag scan coding pattern applied to a 32×32 matrix of elements 1200 in accordance with an embodiment. During encoding, the matrix 1300 is partitioned into (or, during decoding, the matrix 1300 is generated having) four sub-blocks 1302, 1304, 1306, 1308. Forward scan coding between and within the sub-blocks is performed along a forward direction of the arrowed lines from an element position 1310 to an element position 1312 within the matrix 1300. Inverse scan coding between and within the sub-blocks is performed along an inverse direction of the arrowed lines from the element position 1312 to the element position 1310 within the matrix 1300.

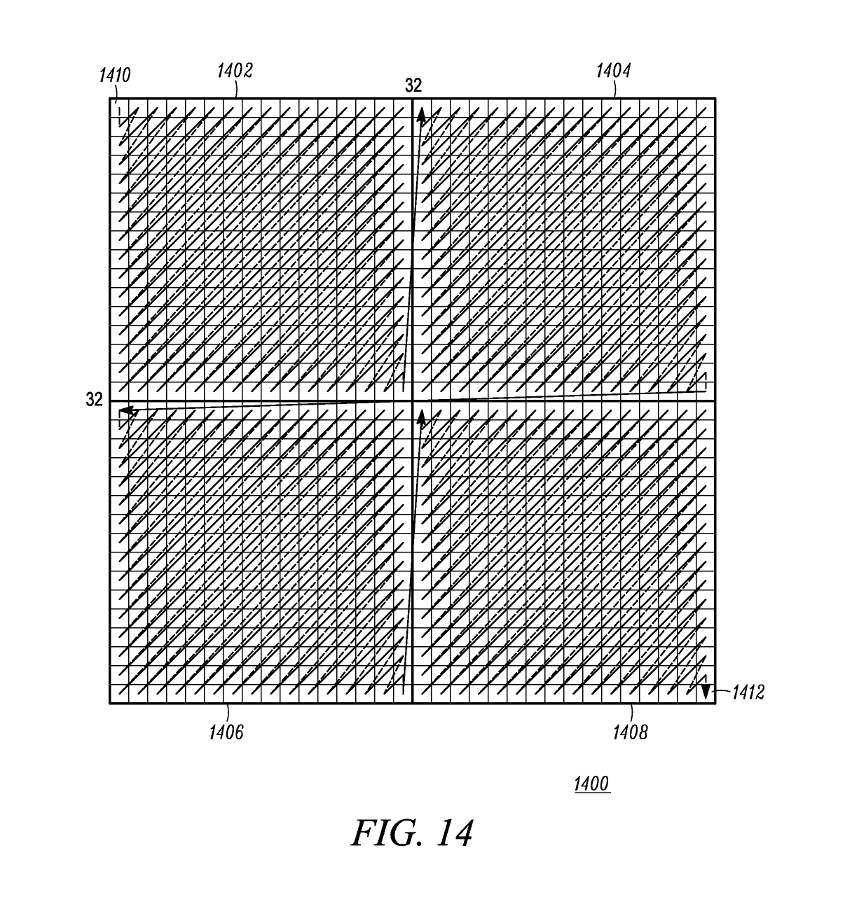

FIG. 14 illustrates a wavefront scan coding pattern applied to a 32×32 matrix of elements 1400 in accordance with an embodiment. During encoding, the matrix 1400 is partitioned into (or, during decoding, the matrix 1400 is generated having) four sub-blocks 1402, 1404, 1406, 1008. Forward scan coding between and within the sub-blocks is performed along a forward direction of the arrowed lines from an element position 1410 to an element position 1412 within the matrix 1400. Inverse scan coding between and within the sub-blocks is performed along an inverse direction of the arrowed lines from the element position 1412 to the element position 1410 within the matrix 1400.

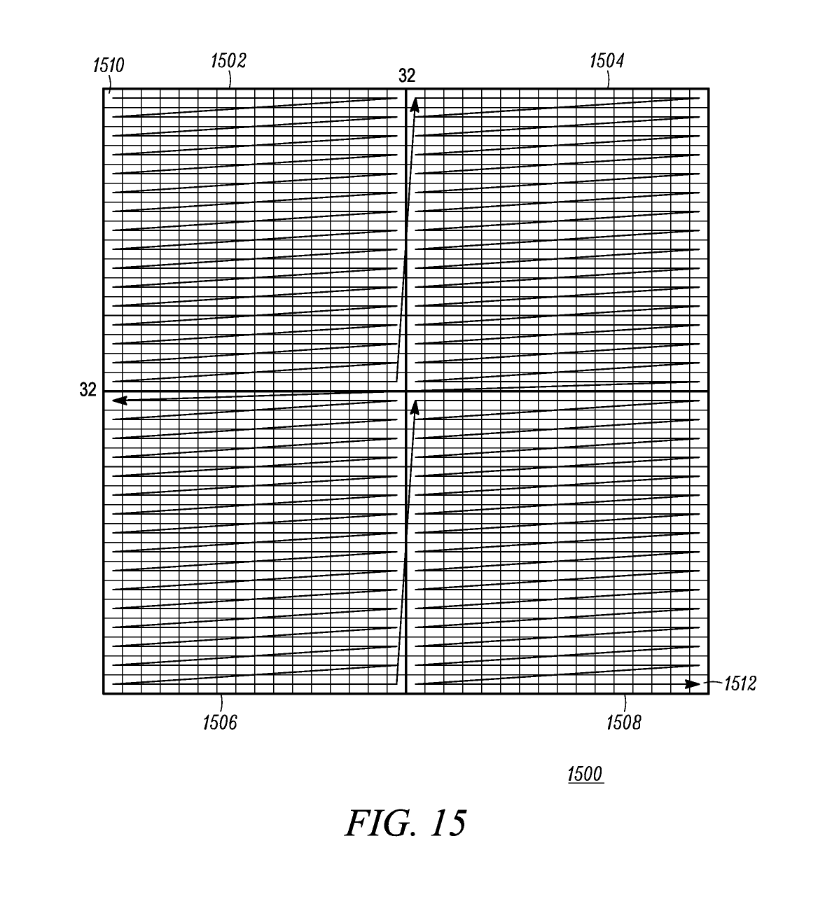

FIG. 15 illustrates a horizontal scan coding pattern applied to a 32×32 matrix of elements 1500 in accordance with an embodiment. During encoding, the matrix 1500 is partitioned into (or, during decoding, the matrix 1500 is generated having) four sub-blocks 1502, 1504, 1506, 1508. Forward scan coding between and within the sub-blocks is performed along a forward direction of the arrowed lines from an element position 1510 to an element position 1512 within the matrix 1500. Inverse scan coding between and within the sub-blocks is performed along an inverse direction of the arrowed lines from the element position 1512 to the element position 1510 within the matrix 1500.

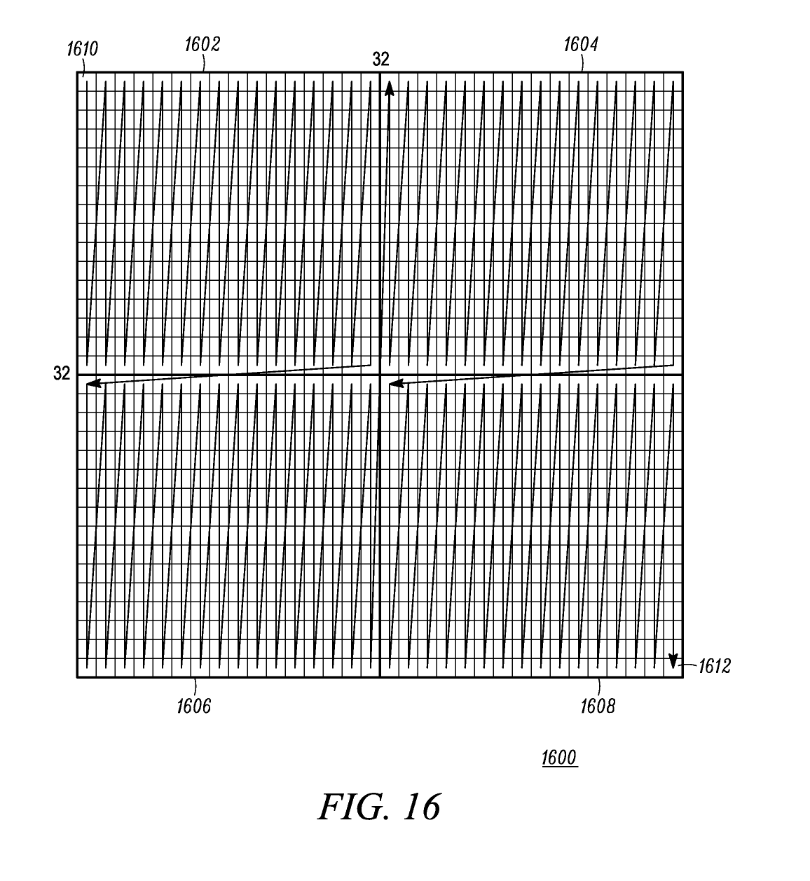

FIG. 16 illustrates a vertical scan coding pattern applied to a 32×32 matrix of elements 1600 in accordance with an embodiment. During encoding, the matrix 1600 is partitioned into (or, during decoding, the matrix 1200 is generated having) four sub-blocks 1602, 1604, 1606, 1608. Forward scan coding between and within the sub-blocks is performed along a forward direction of the arrowed lines from an element position 1610 to an element position 1612 within the matrix 1600. Inverse scan coding between and within the sub-blocks is performed along an inverse direction of the arrowed lines from the element position 1612 to the element position 1610 within the matrix 1600.

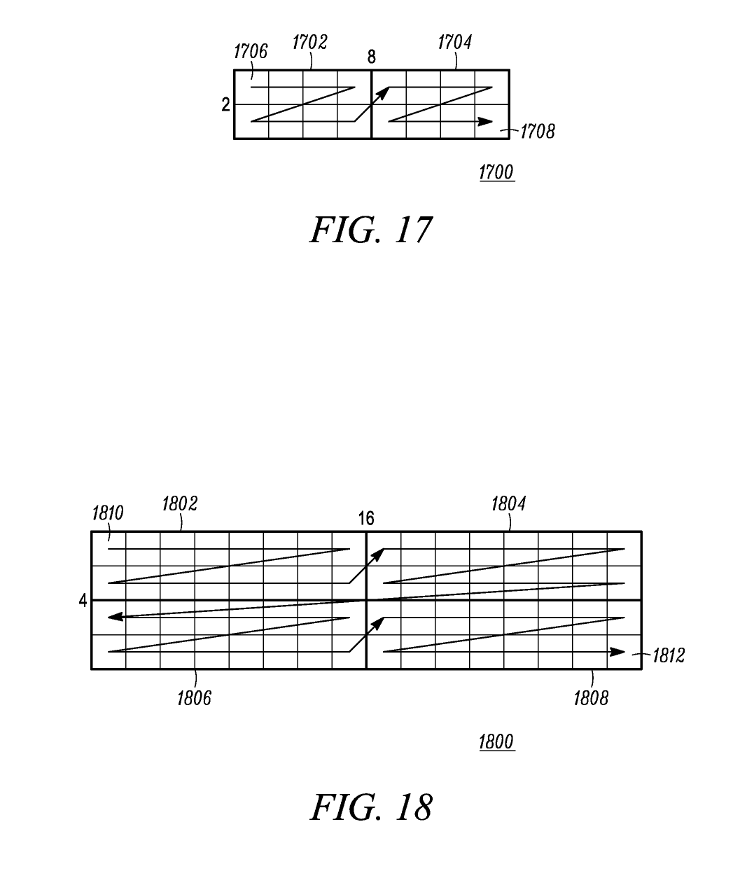

FIG. 17 illustrates a horizontal scan coding pattern applied to an 8×2 matrix of elements 1700 in accordance with an embodiment. During encoding, the matrix 1700 is partitioned into (or, during decoding, the matrix 1700 is generated having) two sub-blocks 1702 and 1704. Forward scan coding between and within the sub-blocks is performed along a forward direction of the arrowed lines from an element position 1706 to an element position 1708 within the matrix 1700. Inverse scan coding between and within the sub-blocks is performed along an inverse direction of the arrowed lines from the element position 1708 to the element position 1706 within the matrix 1700.

FIG. 18 illustrates a horizontal scan coding pattern applied to a 16×4 matrix of elements 1800 in accordance with an embodiment. During encoding, the matrix 1800 is partitioned into (or, during decoding, the matrix 1800 is generated having) four sub-blocks 1802, 1804, 1806, and 1808. Forward scan coding between and within the sub-blocks is performed along a forward direction of the arrowed lines from an element position 1810 to an element position 1812 within the matrix 1800. Inverse scan coding between and within the sub-blocks is performed along an inverse direction of the arrowed lines from the element position 1812 to the element position 1810 within the matrix 1800.

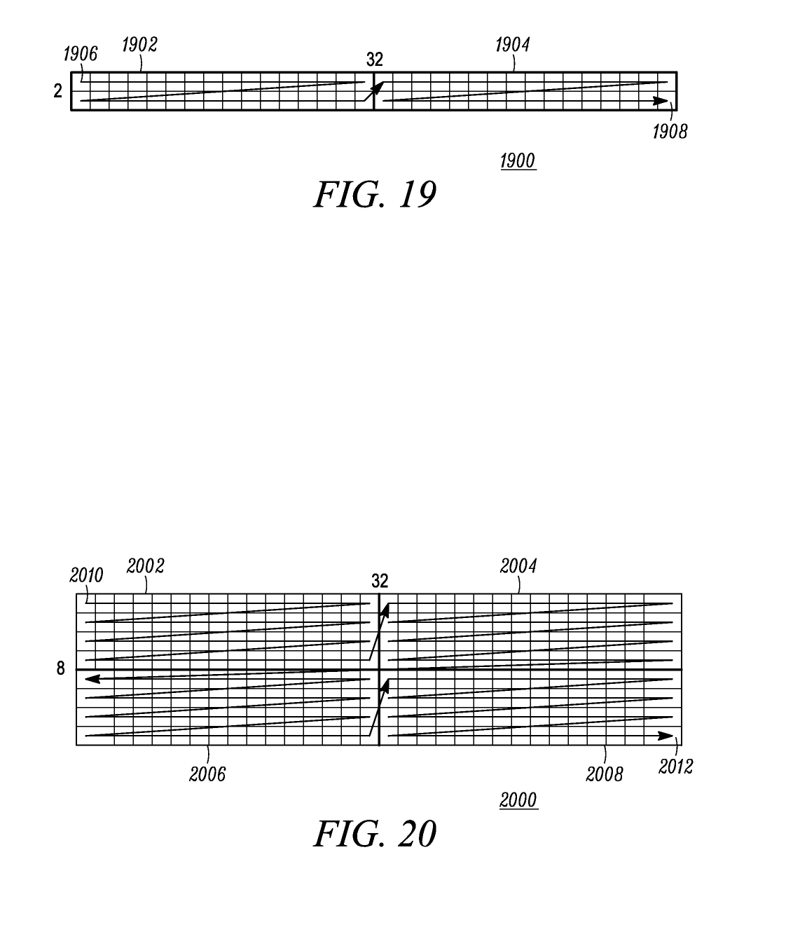

FIG. 19 illustrates a horizontal scan coding pattern applied to a 32×2 matrix of elements 1900 in accordance with an embodiment. During encoding, the matrix 1900 is partitioned into (or, during decoding, the matrix 1900 is generated having) two sub-blocks 1902 and 1904. Forward scan coding between and within the sub-blocks is performed along a forward direction of the arrowed lines from an element position 1906 to an element position 1908 within the matrix 1900. Inverse scan coding between and within the sub-blocks is performed along an inverse direction of the arrowed lines from the element position 1908 to the element position 1906 within the matrix 1900.

FIG. 20 illustrates a horizontal scan coding pattern applied to a 32×8 matrix of elements 2000 in accordance with an embodiment. During encoding, the matrix 2000 is partitioned into (or, during decoding, the matrix 2000 is generated having) four sub-blocks 2002, 2004, 2006, and 2008. Forward scan coding between and within the sub-blocks is performed along a forward direction of the arrowed lines from an element position 2010 to an element position 2012 within the matrix 2000. Inverse scan coding between and within the sub-blocks is performed along an inverse direction of the arrowed lines from the element position 2012 to the element position 2010 within the matrix 2000.

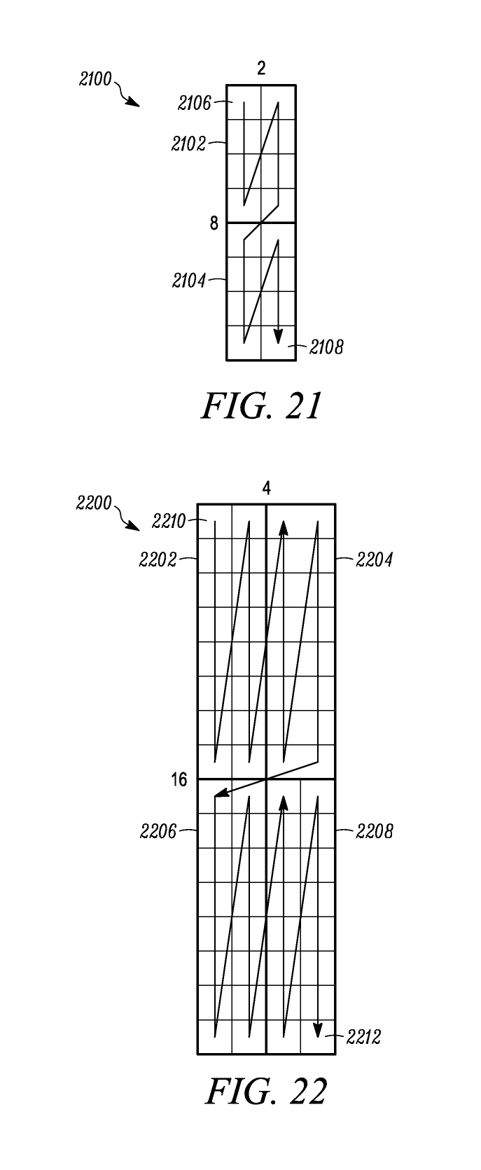

FIG. 21 illustrates a vertical scan coding pattern applied to a 2×8 matrix of elements 2100 in accordance with an embodiment. During encoding, the matrix 2100 is partitioned into (or, during decoding, the matrix 2100 is generated having) two sub-blocks 2102 and 2104. Forward scan coding between and within the sub-blocks is performed along a forward direction of the arrowed lines from an element position 2106 to an element position 2108 within the matrix 2100. Inverse scan coding between and within the sub-blocks is performed along an inverse direction of the arrowed lines from the element position 2108 to the element position 2106 within the matrix 2100.

FIG. 22 illustrates a vertical scan coding pattern applied to a 4×16 matrix of elements 2200 in accordance with an embodiment. During encoding, the matrix 2200 is partitioned into (or, during decoding, the matrix 2200 is generated having) four sub-blocks 2202, 2204, 2206, and 2208. Forward scan coding between and within the sub-blocks is performed along a forward direction of the arrowed lines from an element position 2210 to an element position 2212 within the matrix 2200. Inverse scan coding between and within the sub-blocks is performed along an inverse direction of the arrowed lines from the element position 2212 to the element position 2210 within the matrix 2200.

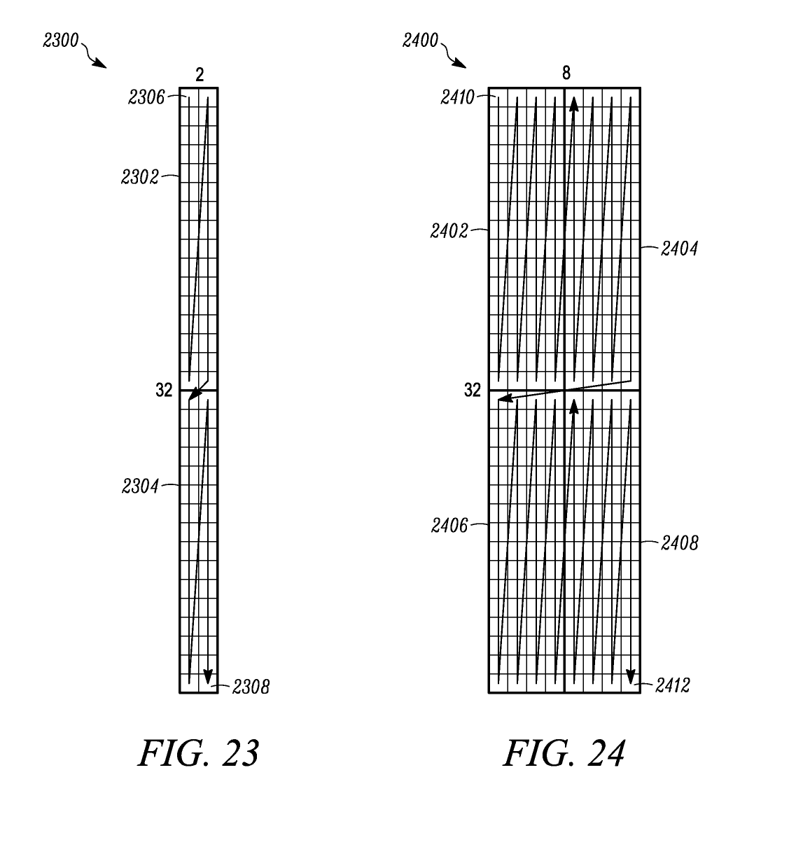

FIG. 23 illustrates a vertical scan coding pattern applied to a 2×32 matrix of elements 2300 in accordance with an embodiment. During encoding, the matrix 2300 is partitioned into (or, during decoding, the matrix 2300 is generated having) two sub-blocks 2302 and 2304. Forward scan coding between and within the sub-blocks is performed along a forward direction of the arrowed lines from an element position 2306 to an element position 2308 within the matrix 2300. Inverse scan coding between and within the sub-blocks is performed along an inverse direction of the arrowed lines from the element position 2308 to the element position 2306 within the matrix 2300.

FIG. 24 illustrates a vertical scan coding pattern applied to an 8×32 matrix of elements 2400 in accordance with an embodiment. During encoding, the matrix 2400 is partitioned into (or, during decoding, the matrix 2400 is generated having) four sub-blocks 2402, 2404, 2406, and 2408. Forward scan coding between and within the sub-blocks is performed along a forward direction of the arrowed lines from an element position 2410 to an element position 2412 within the matrix 2400. Inverse scan coding between and within the sub-blocks is performed along an inverse direction of the arrowed lines from the element position 2412 to the element position 2410 within the matrix 2400.

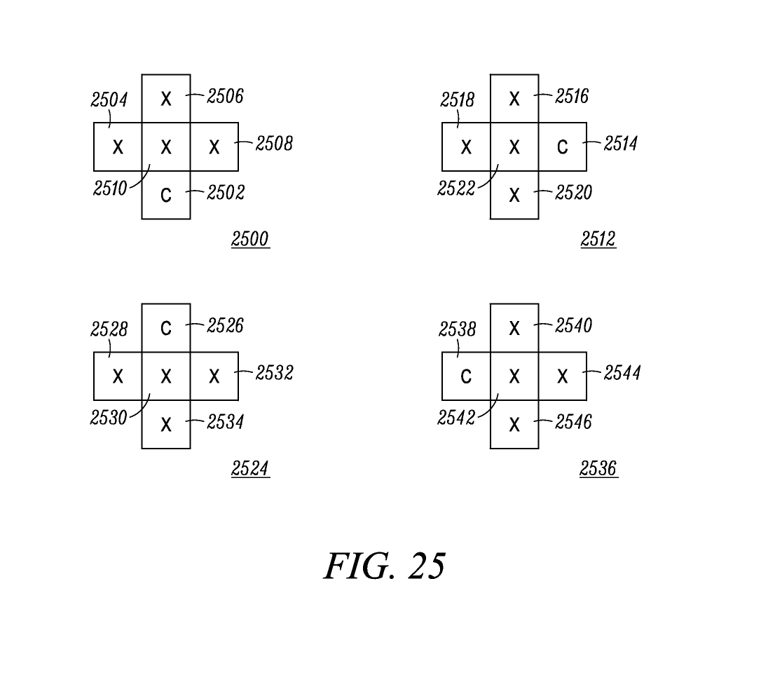

CABAC entropy coding allows for context modeling, which provides estimates of conditional probabilities of the coding elements or symbols. Utilizing suitable context models, given inter-symbol redundancy can be exploited by switching between different probability models according to already coded symbols (represented as “x” in the figures) in the neighborhood of a current element (represented as “C” in the figures. FIGS. 25-27 illustrate context models when scan coding elements using horizontal and vertical scan coding patterns in both the forward and reverse directions.

FIG. 25 illustrates a specific example for forming the context model for a current element using its coded neighbors when the scan coding direction is forward. As can be seen, with the use of those specific neighbors in forming the context model, as shown in diagrams 2500 and 2512, parallel coding is possible. Diagram 2500 illustrates the context model for scan coding using the horizontal scan coding pattern with a current element C at 2502 and its coded neighbors at 2504-2510. Diagram 2512 illustrates the context model for scan coding using the vertical scan coding pattern with a current element C at 2514 and its coded neighbors at 2516-2522. Note that for a current element C at quadrant boundaries, one or more neighbors marked as x in diagrams 2500 and 2512 may either be not yet coded or not available. In that case, only the available coded neighbors are used in forming the context model for the current element C.

Diagrams 2524 and 2536 illustrate a specific example for forming the context model for a current element using its coded neighbors when the scan coding direction is reverse. Diagram 2524 illustrates the context model for scan coding using the horizontal scan coding pattern with a current element C at 2526 and its coded neighbors at 2528-2534. Diagram 2536 illustrates the context model for scan coding using the vertical scan coding pattern with a current element C at 2538 and its coded neighbors at 2540-2546.

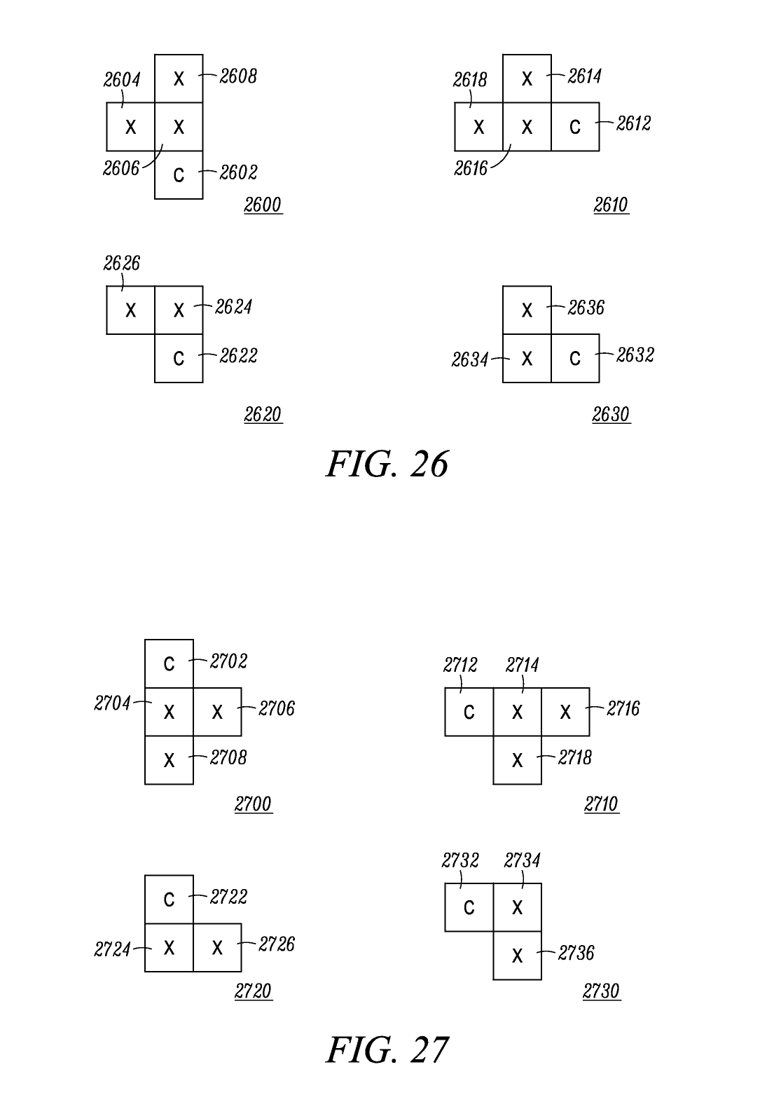

To have parallel processing of four quadrants, the coded neighbors x for a current element C within a quadrant are limited to the coded neighbors within the same quadrant. In accordance with another embodiment, FIG. 26 shows additional examples (diagrams 2600, 2610, 2620, and 2630) for forming context models for a current element when the scan coding direction is forward, which do not require checking whether the current element is at a boundary of a quadrant. More particularly, diagram 2600 illustrates the context model for scan coding using the horizontal scan coding pattern with a current element C at 2602 and its coded neighbors at 2604-2608. Diagram 2610 illustrates the context model for scan coding using the vertical scan coding pattern with a current element C at 2612 and its coded neighbors at 2614-2618. Diagram 2620 illustrates the context model for scan coding using the horizontal scan coding pattern with a current element C at 2622 and its coded neighbors at 2624-2626. Diagram 2630 illustrates the context model for scan coding using the vertical scan coding pattern with a current element C at 2632 and its coded neighbors at 2634-2636.

FIG. 27 shows additional examples for forming context models (diagrams 2700, 2710, 2720, and 2730) for a current element when scan direction is reverse, which do not require checking whether the current element is at a boundary of a quadrant. More particularly, diagram 2700 illustrates the context model for scan coding using the horizontal scan coding pattern with a current element C at 2702 and its coded neighbors at 2704-2708. Diagram 2710 illustrates the context model for scan coding using the vertical scan coding pattern with a current element C at 2712 and its coded neighbors at 2714-2718. Diagram 2720 illustrates the context model for scan coding using the horizontal scan coding pattern with a current element C at 2722 and its coded neighbors at 2724-2726. Diagram 2730 illustrates the context model for scan coding using the vertical scan coding pattern with a current element C at 2732 and its coded neighbors at 2734-2736.

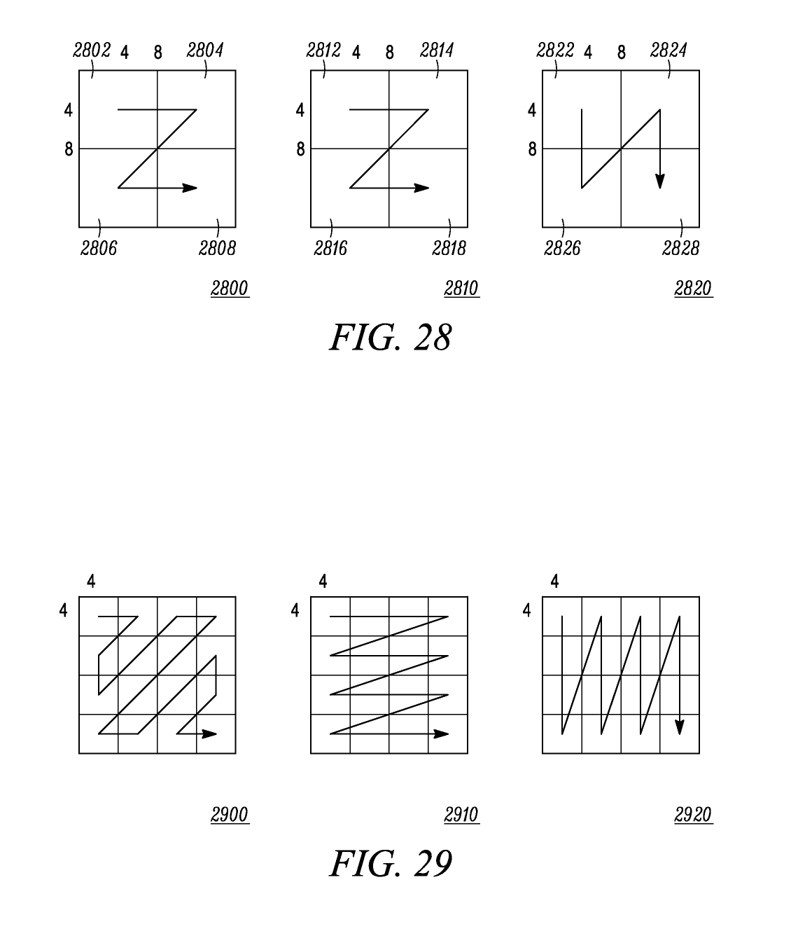

In accordance with another embodiment as shown in FIG. 28, an 8×8 matrix of elements is partitioned into four 4×4 sub-blocks, and a scan coding pattern is applied between and within the sub-blocks. More particularly, an 8×8 matrix of elements 2800 is partitioned into four sub-blocks 2802, 2804, 2806, and 2808 and a zigzag scan coding pattern is applied between and within the sub-blocks along either a forward direction (as shown by the direction of the arrowed lines) or an inverse direction of the scan coding pattern. An 8×8 matrix of elements 2810 is partitioned into four sub-blocks 2812, 2814, 2816, and 2818 and a horizontal scan coding pattern is applied between and within the sub-blocks along either a forward direction (as shown by the direction of the arrowed lines) or an inverse direction of the scan coding pattern. An 8×8 matrix of elements 2820 is partitioned into four sub-blocks 2822, 2824, 2826, and 2828 and a vertical scan coding pattern is applied between and within the sub-blocks along either a forward direction (as shown by the direction of the arrowed lines) or an inverse direction of the scan coding pattern.

In accordance with another embodiment as shown in FIG. 29, a 16×16 matrix of elements is partitioned into 16 4×4 sub-blocks, and a scan coding pattern is applied between and within the sub-blocks. More particularly, a 16×16 matrix of elements 2900 is partitioned into 16 sub-blocks and a zigzag scan coding pattern is applied between and within the sub-blocks along either a forward direction (as shown by the direction of the arrowed lines) or an inverse direction of the scan coding pattern. A 16×16 matrix of elements 2910 is partitioned into 16 sub-blocks and a horizontal scan coding pattern is applied between and within the sub-blocks along either a forward direction (as shown by the direction of the arrowed lines) or an inverse direction of the scan coding pattern. A 16×16 matrix of elements 2920 is partitioned into 16 sub-blocks and a vertical scan coding pattern is applied between and within the sub-blocks along either a forward direction (as shown by the direction of the arrowed lines) or an inverse direction of the scan coding pattern.

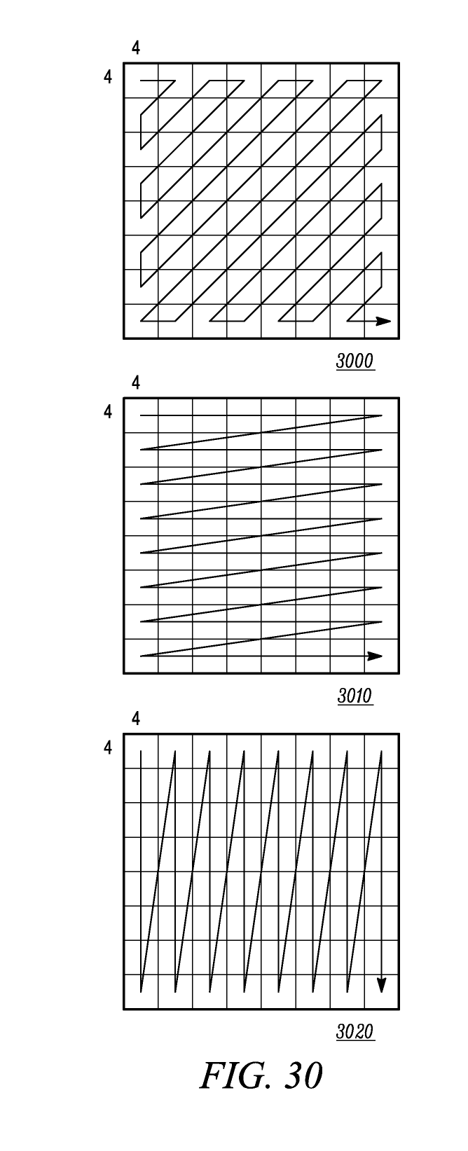

In accordance with another embodiment as shown in FIG. 30, a 32×32 matrix of elements is partitioned into 64 4×4 sub-blocks, and a scan coding pattern is applied between and within the sub-blocks. More particularly, a 32×32 matrix of elements 3000 is partitioned into 64 sub-blocks and a zigzag scan coding pattern is applied between and within the sub-blocks along either a forward direction (as shown by the direction of the arrowed lines) or an inverse direction of the scan coding pattern. A 32×32 matrix of elements 3010 is partitioned into 64 sub-blocks and a horizontal scan coding pattern is applied between and within the sub-blocks along either a forward direction (as shown by the direction of the arrowed lines) or an inverse direction of the scan coding pattern. A 32×32 matrix of elements 3020 is partitioned into 64 sub-blocks and a vertical scan coding pattern is applied between and within the sub-blocks along either a forward direction (as shown by the direction of the arrowed lines) or an inverse direction of the scan coding pattern.

FIG. 31 illustrates a horizontal scan coding pattern for scan coding a 16×16 matrix 3100 of elements during coefficient non-zero in accordance with an embodiment. Matrix 3100 is partitioned into four sub-blocks 3102, 3104, 3106, and 3108. The horizontal scan coding pattern is applied between and within the sub-blocks along an inverse direction (as shown by the direction of the arrowed lines) beginning at a first non-zero transform coefficient at a location 3110 in the matrix 3100 (which is closest to the bottom right corner) and ending at a transform coefficient at a location 3112 in the matrix 3100.

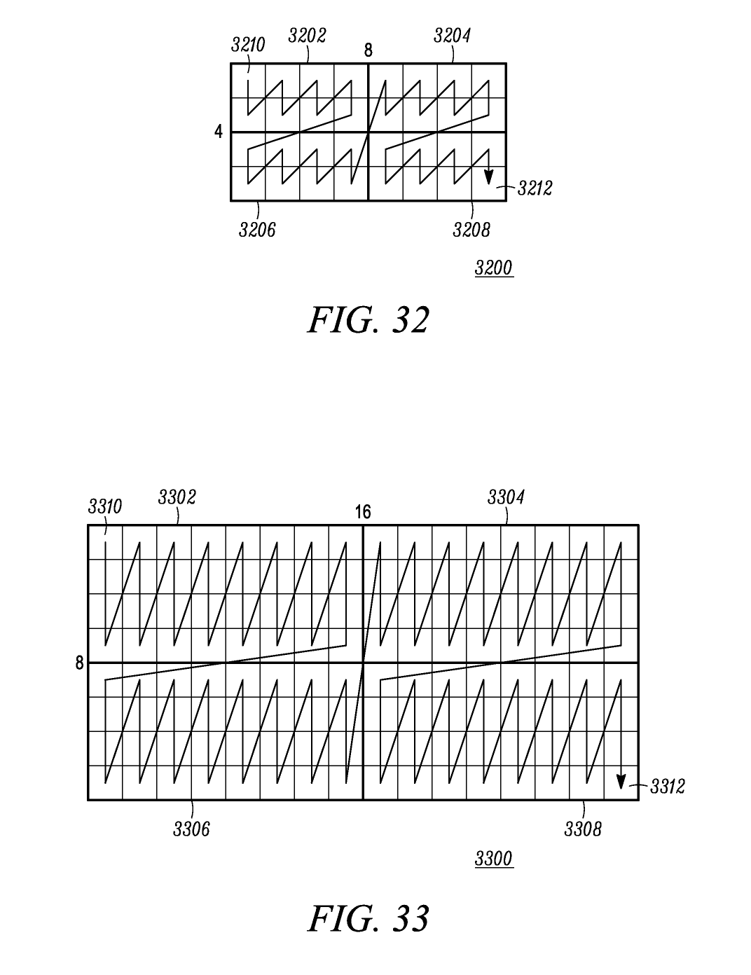

FIG. 32 illustrates a vertical scan coding pattern applied to an 8×4 matrix of elements 3200 in accordance with an embodiment. During encoding, the matrix 3200 is partitioned into (or, during decoding, the matrix 3200 is generated having) four sub-blocks 3202, 3204, 3206, and 3208. Forward scan coding between and within the sub-blocks is performed along a forward direction of the arrowed lines from an element position 3210 to an element position 3212 within the matrix 3200. Inverse scan coding between and within the sub-blocks is performed along an inverse direction of the arrowed lines from the element position 3212 to the element position 3210 within the matrix 3200.

FIG. 33 illustrates a vertical scan coding pattern applied to a 16×8 matrix of elements 3300 in accordance with an embodiment. During encoding, the matrix 3300 is partitioned into (or, during decoding, the matrix 3300 is generated having) four sub-blocks 3302, 3304, 3306, and 3308. Forward scan coding between and within the sub-blocks is performed along a forward direction of the arrowed lines from an element position 3310 to an element position 3312 within the matrix 3300. Inverse scan coding between and within the sub-blocks is performed along an inverse direction of the arrowed lines from the element position 3312 to the element position 3310 within the matrix 3300.

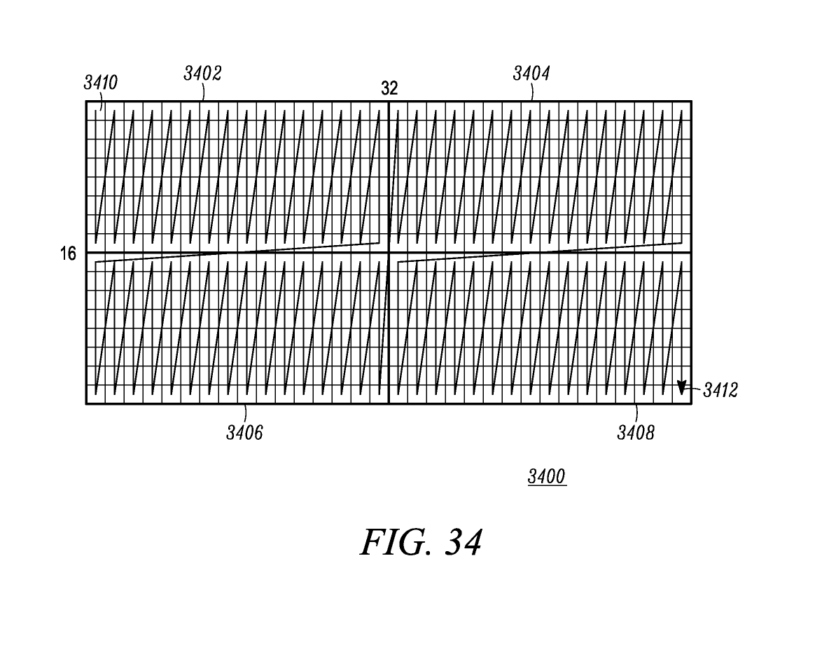

FIG. 34 illustrates a vertical scan coding pattern applied to a 32×16 matrix of elements 3400 in accordance with an embodiment. During encoding, the matrix 3400 is partitioned into (or, during decoding, the matrix 3400 is generated having) four sub-blocks 3402, 3404, 3406, and 3408. Forward scan coding between and within the sub-blocks is performed along a forward direction of the arrowed lines from an element position 3410 to an element position 3412 within the matrix 3400. Inverse scan coding between and within the sub-blocks is performed along an inverse direction of the arrowed lines from the element position 3412 to the element position 3410 within the matrix 3400.

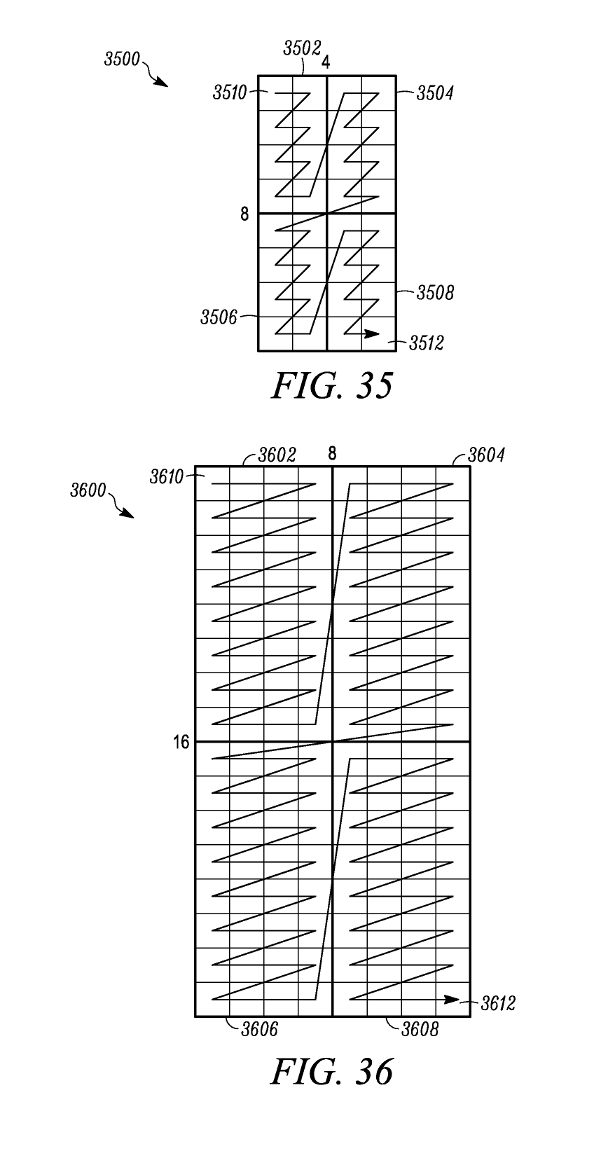

FIG. 35 illustrates a horizontal scan coding pattern applied to a 4×8 matrix of elements 3500 in accordance with an embodiment. During encoding, the matrix 3500 is partitioned into (or, during decoding, the matrix 3500 is generated having) four sub-blocks 3502, 3504, 3506, and 3508. Forward scan coding between and within the sub-blocks is performed along a forward direction of the arrowed lines from an element position 3510 to an element position 3512 within the matrix 3500. Inverse scan coding between and within the sub-blocks is performed along an inverse direction of the arrowed lines from the element position 3512 to the element position 3510 within the matrix 3500.

FIG. 36 illustrates a horizontal scan coding pattern applied to an 8×16 matrix of elements 3600 in accordance with an embodiment. During encoding, the matrix 3600 is partitioned into (or, during decoding, the matrix 3600 is generated having) four sub-blocks 3602, 3604, 3606, and 3608. Forward scan coding between and within the sub-blocks is performed along a forward direction of the arrowed lines from an element position 3610 to an element position 3612 within the matrix 3600. Inverse scan coding between and within the sub-blocks is performed along an inverse direction of the arrowed lines from the element position 3612 to the element position 3610 within the matrix 3700.

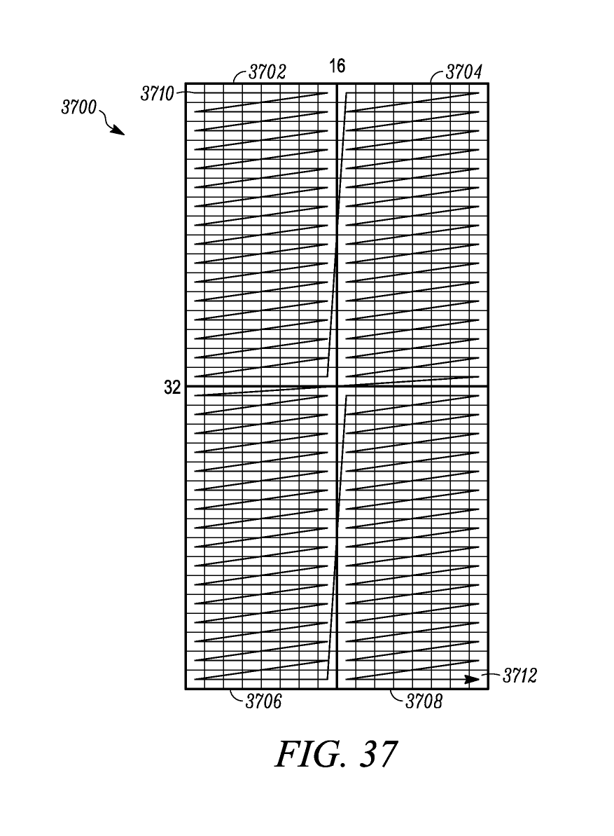

FIG. 37 illustrates a horizontal scan coding pattern applied to a 16×32 matrix of elements 3700 in accordance with an embodiment. During encoding, the matrix 3700 is partitioned into (or, during decoding, the matrix 3700 is generated having) four sub-blocks 3702, 3704, 3706, and 3708. Forward scan coding between and within the sub-blocks is performed along a forward direction of the arrowed lines from an element position 3710 to an element position 3712 within the matrix 3700. Inverse scan coding between and within the sub-blocks is performed along an inverse direction of the arrowed lines from the element position 3712 to the element position 3710 within the matrix 3700.

The following embodiments can be implemented during inter coding. In one embodiment, a zigzag or wavefront scan coding pattern, a horizontal scan coding pattern, or a vertical scan coding pattern in accordance with the present teachings is selected for scan coding an N×M transform unit block of elements based on a size of M and N (e.g., based on the TU size). N is a row width of the TU, and M is a column height of the TU. For example, for a TU of aN×bN, a vertical scan coding pattern in accordance with the present teachings is used when a is greater than b; a horizontal scan coding pattern in accordance with the present teachings is used when b is greater than a; and a zigzag or wavefront scan coding pattern in accordance with the present teachings is used when a is equal to b. Table 1 shows one example of the relationship between the TU size and the scan coding pattern.

TABLE 1

| TU size | Scan coding pattern |
|---|---|
| 2N × 2N | zigzag or wavefront |
| 2N × 1.5N | vertical |
| 2N × N | vertical |
| 2N × 0.5N | vertical |
| 1.5N × 2N | horizontal |
| N × 2N | horizontal |
| N × N | zigzag or wavefront |
| 0.5N × 2N | horizontal |

In another embodiment, a zigzag or wavefront scan coding pattern, a horizontal scan coding pattern, or a vertical scan coding pattern in accordance with the present teachings is selected for scan coding an N×M transform unit block of elements based on dimensions of a predictive unit block that includes the transform unit block (e.g., based on the PU sixe). N is a row width of the TU, and M is a column height of the TU. For example, for a TU associated with a PU of aN×bN, a vertical scan coding pattern in accordance with the present teachings is used when a is greater than b; a horizontal scan coding pattern in accordance with the present teachings is used when b is greater than a; and a zigzag or wavefront scan coding pattern in new is used when a is equal to b. Table 2 shows one example of the relationship between the PU size and the scan coding pattern.

TABLE 2

| PU size | Scan coding pattern |
|---|---|
| 2N × 2N | zigzag or wavefront |
| 2N × 1.5N | vertical |
| 2N × N | vertical |
| 2N × 0.5N | vertical |
| 1.5N × 2N | horizontal |
| N × 2N | horizontal |
| N × N | zigzag or wavefront |
| 0.5N × 2N | horizontal |

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In general, for purposes of these teachings, devices are configured or adapted with functionality in accordance with embodiments of the present disclosure as described in detail above with respect to the FIGS. 2-37. “Adapted,” “configured” or “capable of” as used herein means that the indicated devices are implemented using hardware or a combination of hardware and processing devices programmed with software and/or firmware to perform the desired functionality.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, performed by an encoder during inter coding, for processing a block of transform coefficients, the method comprising:
receiving, during inter coding, an N×M block of transform coefficients, wherein N is a row width of the block and M is a column height of the block;
partitioning the N×M block into a plurality of sub-blocks each comprising a plurality of the transform coefficients;
processing the plurality of sub-blocks, one at a time, in a coding order along a first diagonal scan coding pattern to generate a bit sequence corresponding to the N×M block.

2. The method of claim 1, wherein the processing comprises, for the sub-blocks containing at least one non-zero transform coefficient, coding at least the non-zero transform coefficients in a transform coefficient sequence along a second diagonal scan coding pattern.

3. The method of claim 2, wherein the first diagonal scan coding pattern comprises a first wavefront scan coding pattern.

4. The method of claim 3, wherein the second diagonal scan coding pattern comprises a second wavefront scan coding pattern.

5. The method of claim 2, wherein the coding comprises level and sign coding of the non-zero transform coefficients.

6. The method of claim 1, wherein processing the plurality of sub-blocks comprises coding a sub-block level significance map, and for each sub-block containing at least one non-zero transform coefficient, coding a coefficient level significance map.

7. The method of claim 1, wherein each sub-block has dimensions of 4×4.

8. The method of claim 1, wherein the coding order of the plurality of sub-blocks is along a forward direction of the first diagonal scan coding pattern.

9. The method of claim 1, wherein the coding order of the plurality of sub-blocks is along an inverse direction of the first diagonal scan coding pattern.

10. A method, performed by a decoder during inter coding, for processing a bit sequence, the method comprising:
receiving, during inter coding, a bit sequence corresponding to an N×M block of transform coefficients, wherein N is a row width of the block and M is a column height of the block;
processing the bit sequence to generate a plurality of sub-blocks each comprising a plurality of the transform coefficients, wherein the sub-blocks are generated, one at a time, in a decoding order along a first diagonal scan coding pattern to form the N×M block of transform coefficients.

11. The method of claim 10, wherein the processing comprises, for the sub-blocks containing at least one non-zero transform coefficient, decoding a portion of the bit sequence to generate the transform coefficients in a transform coefficient sequence along a second diagonal scan coding pattern.

12. The method of claim 11, wherein the first diagonal scan coding pattern comprises a first wavefront scan coding pattern, and the second diagonal scan coding pattern comprises a second wavefront scan coding pattern.

13. The method of claim 11, wherein the processing comprises context-adaptive binary arithmetic coding.

14. The method of claim 10, wherein each sub-block has dimensions of 4×4.

15. The method of claim 10, wherein the processing comprises decoding a sub-block level significant map, and for each sub-block containing at least one non-zero transform coefficient, decoding a coefficient level significance map.

16. The method of claim 10 wherein the decoding order for the plurality of sub-blocks is along a forward direction of the first diagonal scan coding pattern or along an inverse direction of the first diagonal scan coding pattern.

17. A system for encoding and decoding video data, the system comprising:
a decoder configured to:
receive, during inter coding, a first bit sequence corresponding to a first N×M block of transform coefficients, wherein N is a row width of the first block and M is a column height of the first block;
process the first bit sequence to generate a first plurality of sub-blocks each comprising a plurality of the transform coefficients of the first block, wherein the sub-blocks of the first plurality are generated, one at a time, in a decoding order along a first wavefront scan coding pattern to form the first N×M block of transform coefficients.

18. The coding system of claim 17 further comprising:
an encoder configured to:
receive, during inter coding, a second N×M block of transform coefficients, wherein N is a row width of the second block and M is a column height of the second block;
partition the second N×M block into a second plurality of sub-blocks each comprising a plurality of the transform coefficients of the second block;
process the second plurality of sub-blocks, one at a time, in a coding order along a second wavefront scan coding pattern to generate a second bit sequence corresponding to the second N×M block.

19. The system of claim 18, wherein each sub-block has dimensions of 4×4.

20. The system of claim 18, wherein the decoding order for the first plurality of sub-blocks is along a forward direction of the first wavefront scan coding pattern or along an inverse direction of the first wavefront scan coding pattern, and wherein the coding order for the second plurality of sub-blocks is along a forward direction of the second wavefront scan coding pattern or along an inverse direction of the second wavefront scan coding pattern.
